(19) United States
(12) Patent Application Publication
(10) Pub. No.: US 2014/0161960 A1
(43) Pub. Date: Jun. 12, 2014

(54) METHOD, SYSTEM AND APPARATUS FOR MANUFACTURING CUSTOM CHOCOLATE ARTICLES AT RETAIL LOCATION

(71) Applicants: Joan Steuer, Los Angeles, CA (US); Kim Rothrock, New York, NY (US)

(72) Inventors: Joan Steuer, Los Angeles, CA (US); Kim Rothrock, New York, NY (US)

(21) Appl. No.: 13/944,831

(22) Filed: Jul. 17, 2013

Related U.S. Application Data
(63) Continuation of application No. 12/111,186, filed on Apr. 28, 2008, now abandoned.

(51) Int. Cl. A23G 1/00; A23G 1/54

(52) U.S. Cl. CPC A23G 1/005; A23G 1/54
USPC 426/631

(57) ABSTRACT

A point-of-sale apparatus for making customized chocolate articles includes one or more temperature-controlled chocolate tempering machine(s) for melting and storing tempered liquid chocolate, a dispensor for dispensing the liquid chocolate into a cavity formed in a single-use mold, a dispensor for depositing one or more selected food product exclusions across the surface of the liquid chocolate, a vibrating table for removing air bubbles and distributing the exclusions evenly, a cooling tunnel for rapidly cooling the chocolate article, and one or more conveyors for moving the single-use chocolate mold and carrying it through the cooling tunnel. The exclusion dispensor may include a hopper having a funnel and a grate with different sized openings corresponding to different sized exclusions. The single-use mold may carry a customer identifier for later identification. The single-use mold containing the solidified custom chocolate article may be deposited directly into a box provided to the customer.

### RELATED APPLICATION INFORMATION

This application is a continuation of U.S. Ser. No. 12/111,186, filed Apr. 28, 2008 and claims the benefit of U.S. Provisional Application Ser. No. 60/915,119 filed on May 1, 2007, hereby incorporated by reference as if set forth fully herein.

### FIELD

The field of the present invention relates generally to the manufacture or fabrication of chocolate articles and, more particularly, to a method, system and apparatus for manufacturing or fabrication of custom chocolate articles at a retail or point-of-sale location.

### BACKGROUND

Chocolate is a food product that is well known and enjoyed by children and adults alike throughout the world. The source of all chocolate is cocoa beans. The primary ingredient in chocolate is chocolate liquor which is typically created when the frictional heat generated by grinding the nib of the deshelled (winnowed) cocoa beans causes cocoa fat or cocoa butter contained in the nib to be expressed from the nib, and combine with the ground cocoa solids to form a smooth liquid paste—also referred to as cocoa mass, unsweetened, bitter, baking or cooking chocolate. The chocolate liquor begins to harden to form unsweetened chocolate when it cools below approximately 95° F. (35° C.) and becomes more solid as it cools further.

When chocolate liquor is mixed with certain percentages of milk solids, sugar, vanilla or vanillin, lecithin, and/or additional cocoa butter, the combinations form dark chocolate (such as bittersweet or semi-sweet) and milk chocolate. Milk chocolate generally contains less chocolate liquor than dark chocolate and has additional milk solids and sugar. White chocolate resembles the composition of milk chocolate, but contains no chocolate liquor although it has cocoa butter.

All chocolate is solid at room temperature and, when heated, can be melted into a molten or liquid state so that it flows as a fluid. Typical melting points for chocolate can range between 86° F.-96° F. (30° C.-36° C.). Liquid chocolate will return to a solid state when cooled back to room temperature.

Chocolate can be poured into molds to form various shapes and sizes, and then cooled into a solid state (e.g., chocolate bars, solid blocks, hollow shells, or shells filled with confectionery material). Chocolate bars and finished molded chocolates are typically produced in a molding process to produce a chocolate product having a high gloss and fine surface detail. Conventional molding typically employs a large number of molds and requires very large, complex and expensive equipment to manipulate and process these molds.

Although the details may vary depending upon the particular manufacturer, in a typical conventional molding process, a chocolate mixture is initially melted at temperatures of about 113° F. (45° C.) and tempered by agitating the chocolate while cooling to somewhere between about 86° F.-90° F. (30° C.-32° C.) to produce liquid tempered chocolate. The tempering of chocolate causes a very small percentage of the fat (e.g., cocoa butter) to form small, stable crystals, which are dispersed throughout the liquid fat phase of the liquid chocolate. This ensures that the chocolate sets with an attractive, glossy and smooth surface and does not “bloom” (go gray). Tempering also ensures that the chocolate will have the desired hard “snap” when broken or bitten into. Uncontrolled crystallization of cocoa butter typically results in crystals of varying size. For example, uncontrolled crystallization may result in the surface of the chocolate appearing mottled and dull, and cause the chocolate to crumble rather than snap when broken. The uniform sheen and snap of properly processed chocolate are the result of consistently small, stable cocoa butter crystals produced by the tempering process. The more stable and consistent the final crystallization, the longer the shelf life of the chocolate, and this is important to most chocolate manufacturers whose products are intended to be sold in supermarkets, drug stores, and other similar large retail establishments. Many retailers generally require a minimum of 9 months of shelf life for chocolate bars and pre-packaged chocolate articles, and a minimum of 6 to 9 months of shelf life for other chocolate articles.

After melting and tempering, the tempered, liquid chocolate is then deposited into a reusable mold, which is shaken to remove air bubbles and to distribute the liquid chocolate evenly within the mold cavity. The chocolate-filled mold is then typically cooled in temperature-controlled cooling tunnels at about 50° F.-58° F. (10° C.-14° C.) with a relative humidity of about 55% or less (although sometimes as high as 70%), to solidify the chocolate. While the temperature and timing of each chocolate manufacturing process is specific to the particular chocolate article being made, the cooling cycle for molded chocolate articles generally takes much more than 10-15 minutes, and is typically anywhere from 30 to 40 minutes. Often, different “zones” are used within a cooling tunnel to prevent sudden temperature changes, with the outer zones closest to ambient temperature, and the inner zones gradually decreasing to the coolest tunnel temperature, then gradually ramping back up to approach ambient temperature. The solidified chocolate article is then removed from the mold, and the process repeats. For mass manufactured chocolate that is intended to have a long shelf life, it is critical that the chocolate be cooled very carefully to maintain gloss and smooth texture. Even a slight temperature or humidity change at the wrong time may cause the destabilization of the cocoa butter crystals resulting in “fat bloom” or “sugar bloom” leading to an undesirable gray surface and/or gritty texture. These phenomena may manifest relatively quickly or even after some days or weeks after completed manufacturing of the chocolate article.

Chocolate molding processes are known in the art, but such conventional molding processes typically require a great deal of space and a 30 to 40 minute time period in a typical cooling tunnel for optimal crystallization of the cocoa butter to ensure that the finished chocolate has the shiny appearance, smooth and even texture, and snap for best shelf life. As noted above, these processes generally require careful graduated control of temperature with cooling tunnel zones. Such conventional processes are not capable of being utilized in retail or point-of-sale locations for the manufacture of custom chocolate articles based on an individual customer's preferences or in a time frame appropriate for retail demands (or a retail selling environment). Moreover, conventional machinery used in mass manufacturing of chocolate articles does not lend itself very well to use in a point-of-sale establishment and, in particular, does not lend itself well to making customized chocolate articles.

### SUMMARY

A preferred method, system and apparatus for manufacturing or fabricating custom chocolate articles (e.g., chocolate bars) is disclosed that is capable of being utilized in retail and point-of sale locations. According to various embodiments, a point-of-sale apparatus is provided for customizing a chocolate article at a retail location, allowing customers to select a unique combination of chocolate type and “exclusions” (e.g., edible toppings, particulates and other ingredients). The apparatus may include one or more tanks for holding various types of tempered liquid chocolate, a dispensor for dispensing the tempered liquid chocolate of a selected type into a mold, an exclusion depositor for depositing one or more selected exclusions onto the surface of the tempered liquid chocolate while in the mold, and a cooling tunnel for rapidly cooling the chocolate article and thereby solidifying it significantly more rapidly than is done in typical conventional mass chocolate manufacturing of molded chocolate articles.

In one embodiment, after a customer selects the type of chocolate desired and various exclusions to be deposited on the surface of the custom chocolate article, a mold bearing the customer's unique identifier is carried on a conveyor system to a chocolate dosing station, where the customer-specified, tempered chocolate is automatically deposited into the mold having a cavity corresponding to the desired shape of the chocolate article. The mold containing the tempered, liquid chocolate continues on the conveyor to a vibrating plate for evenly distributing the tempered chocolate within the mold cavity. The conveyor then carries the mold to an exclusion depositor, which distributes the customer-specified exclusions across the surface of the tempered liquid chocolate within the mold cavity. The conveyor system carries the mold containing the tempered liquid chocolate and customer-selected exclusions through one or more cooling tunnels, which may preferably include a spiral conveyor cooling unit to minimize cooling space requirements and visually enhance the customer's experience, and to cool and solidify the custom chocolate article in a period of time that is substantially less than conventional cooling times for molded chocolate articles in mass production. The mold containing the solidified custom chocolate article is then deposited in a box or other storage container, which is provided to the customer.

Further embodiments, variations and enhancements are also disclosed herein.

### BRIEF DESCRIPTION OF THE DRAWINGS

The method, system and apparatus for manufacturing custom chocolate articles at a retail or point-of-sale location are explained further below by reference to a preferred embodiment and the accompanying drawings, in which:

FIG. 1 is a perspective view diagram of a preferred system for manufacturing custom chocolate articles.

FIG. 2 is a diagram of a top plan view of the preferred system illustrated in FIG. 1.

FIG. 3 is a top plan view diagram of a system for manufacturing custom chocolate articles in accordance with another embodiment as disclosed herein.

FIG. 4-1 is an oblique view diagram of a hopper for guiding exclusion food products atop a custom chocolate article, and FIG. 4-2 is a top view diagram of the hopper showing a filtering tray or grate with a pattern of holes for allowing the exclusion food products to sift through for even placement atop the custom chocolate article.

FIG. 5 is a process flow diagram in accordance with one embodiment for manufacturing a custom chocolate article.

FIG. 6 is a process flow diagram in accordance with another embodiment for manufacturing a custom chocolate article.

FIG. 7 is a process flow diagram in accordance with yet another embodiment for manufacturing a custom chocolate article, having a greater degree of automation.

FIG. 8 is an oblique view diagram of a versatile spout for providing different chocolate flow rates/patterns corresponding to different sized molds.

FIG. 9 is an illustration of the spout of FIG. 8 shown positioned on a tempering machine having a wheel for circulating the liquid chocolate.

FIGS. 10-1 and 10-2 are an oblique view diagram and a top view diagram, respectively, of a multi-track conveyor as may be used in various custom chocolate article manufacturing processes as described herein, while FIG. 10-3 is a cross-sectional view of the multi-track conveyor as shown in FIG. 10-2.

FIG. 11 is a diagram showing examples of completed chocolate articles of different sizes resulted from different-sized single-use chocolate molds.

FIG. 12 is a block diagram showing an example of an automated process control system for controlling the manufacture of custom chocolate articles as may be used in whole or part in connection with various embodiments as disclosed herein.

### DESCRIPTION OF PREFERRED EMBODIMENTS

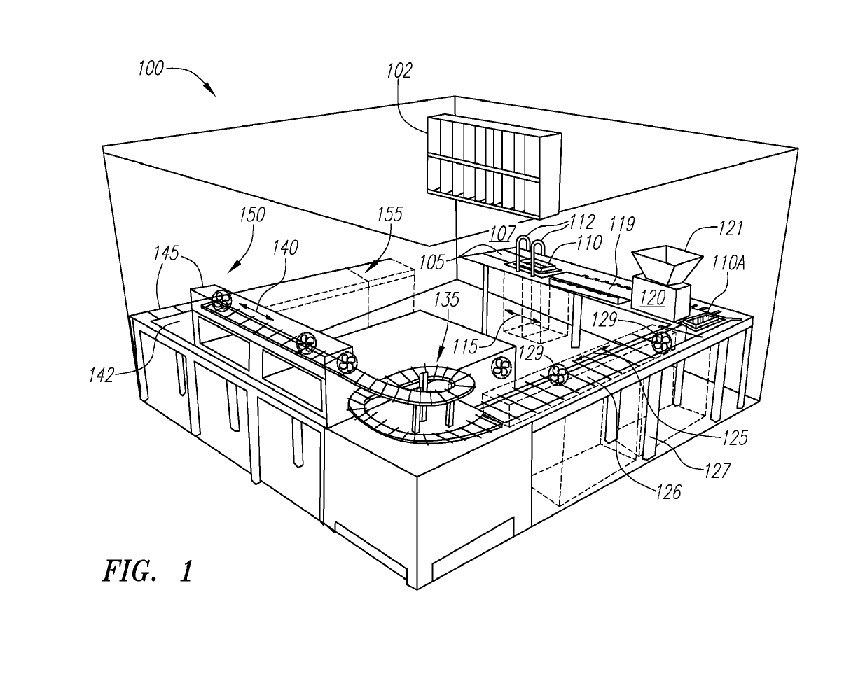

Preferred methods, systems and apparatuses for manufacturing custom chocolate articles at a retail or point-of-sale location (such as a kiosk) are illustrated in FIGS. 1, 2 and 3, and in other accompanying figures or else explained in the text herein. While the systems and apparatuses can advantageously be used to manufacture custom chocolate articles at a retail or point-of-sale location, they may also be used in other environments and manufacturing facilities. Accordingly, unless indicated otherwise, there is no intention to limit use of the disclosed preferred methods, systems and apparatuses to retail or point-of-sale locations.

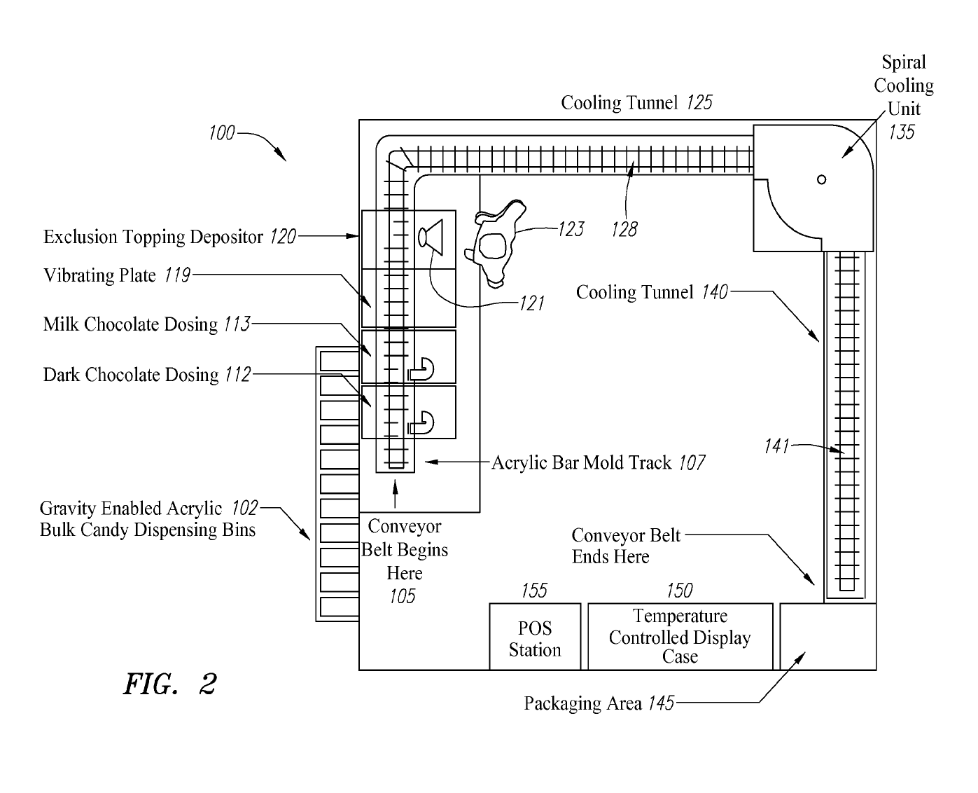

The systems and apparatuses disclosed herein are preferably of a size and shape that will readily fit within a retail location where customers can purchase, view and participate in the manufacture of customer-specified custom chocolate articles (e.g., chocolate bars). For example, in an embodiment illustrated in FIGS. 1 and 2, which show an oblique three-dimensional view and a top plan view, respectively, the system and apparatus are configured to preferably fit within a 15 ft.×15 ft. footprint, which is conducive for a retail location or kiosk. However, there is no intention to limit the disclosed systems and apparatuses to any particular size, shape or configuration.

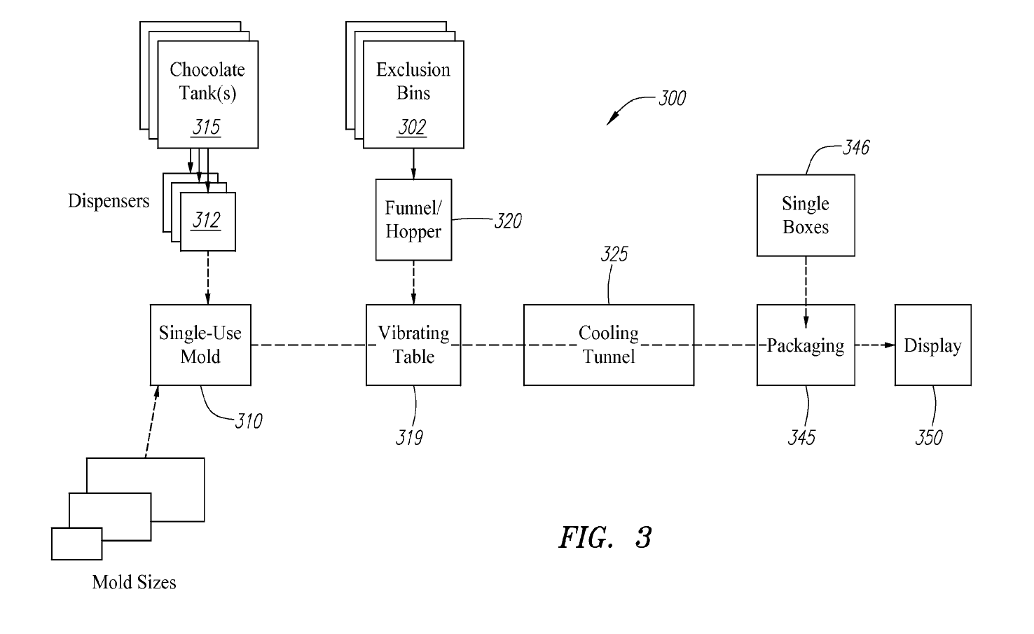

An example of a preferred process for the point-of-sale custom manufacture of chocolate articles is conceptually illustrated in FIG. 3. As shown therein, the process 300 involves dispensing tempered liquid chocolate into a single-use mold 310, adding exclusions, vibrating the mold 310 to remove air bubbles and evenly distribute the exclusions, cooling the mold 310 in a cooling tunnel 325, and packaging the single-use mold 310 at a packaging station 345 for optional placement in a temperature-controlled display area 350 until customer pickup. In the example of FIG. 3, the single-use mold 310 may be selected from any of multiple different sizes (e.g., small, medium or large) and might range from a few inches to over a foot in length. In addition to a selection of different mold sizes (which may include different mold shapes, designs or embossments), different types of chocolate may optionally be selected. The different types of chocolate (e.g., dark, white or milk) may be stored in corresponding tanks 315, and one or more dispensers 312 may be provided for dispensing the chocolate into the single-use mold 310. Examples of dispensers include standard or customized dosing heads or spouts, attributes of which are described later herein by way of specific examples.

The single-use mold 310 may be automatically conveyed from the chocolate dispensing or dosing station to the exclusion depositing station, vibrating station, cooling tunnel, and packaging station, or else may be manually moved from station to station as needed. At the exclusion depositing station, one or more selected exclusions are preferably placed into a hopper 320 which facilitates the even distribution of the exclusions on the surface of the tempered liquid chocolate in the single-use mold 310. Depending on the size/weight of the exclusions and the relative density of the liquid chocolate, some of the exclusions may partially or wholly sink into the liquid chocolate, although many will typically remain on the surface. By contrast, in conventional mass chocolate production, added inclusions are either blended with the chocolate in advance of depositing in the mold or else added sequentially. The inclusions in such cases are often warmed to the same temperature as the chocolate to maintain maximum stability for long term shelf life. In addition, in conventional mass chocolate production different inclusion types are typically added sequentially, rather than different types being added to the chocolate together.

Returning now to FIG. 3, after the exclusions are deposited, a vibrating unit 319 may be activated to help remove air bubbles from the chocolate and more evenly distribute the exclusions. The mold 310 containing the tempered liquid chocolate together with the exclusions then enters a cooling tunnel 325 and is rapidly cooled for a time period of, e.g., 8 to 12 minutes. The mold 310 then exits the cooling tunnel 325 and is boxed at a packaging station 345 into a single-article box and/or placed in a temperature-controlled display case.

Turning now to the particular embodiment illustrated in FIGS. 1 and 2, the point-of-sale custom chocolate article manufacturing system 100 preferably comprises a point of sale (POS) station 155, an exclusion station preferably comprising a plurality of dispensing containers 102, a conveyor system for carrying a mold 110 (or 110A) having a cavity corresponding to the desired shape of the chocolate article, a chocolate dosing or dispensing station 112 for depositing customer-specified, tempered, liquid chocolate into the mold cavity of the mold 110, a vibrating unit 119 for evenly distributing the tempered, liquid chocolate within the mold cavity, an exclusion depositor 120 for depositing the customer-specified exclusions onto the surface of the chocolate contained within the mold cavity, and at least one cooling station 125, 135 and/or 140 to cool and solidify the chocolate contained within the mold cavity.

The POS station 155 is preferably provided as a location where an operator/employee 123 can greet a customer, explain the custom chocolate concept, take orders, and collect money or process credit cards for custom chocolate articles. When the customer pays for a custom chocolate article, the operator/employee 123 preferably provides the customer with a receipt (not shown) having a unique identifier (e.g., numbers, letters, or other identifiers or indicia). A duplicate adhesive-backed receipt is also generated bearing the same unique identifier as that provided to the customer at the time of purchase.

At the time of purchase, the operator/employee 123 also preferably provides the customer with a portion cup or other portion-controlled container (not shown) having a fixed volume (e.g., 4 oz.) and, optionally, a removable lid. The removable lid may, for example, take the form of a hinged or sliding lid that can be moved to allow access to the cavity of the portion cup or other container. The operator/employee 123 may place the duplicate adhesive-backed receipt (or a portion thereof bearing the unique identifier) onto the portion cup lid or other area of the portion container that is provided to the customer. Alternatively, the duplicate adhesive-backed receipt could be applied to the bottom or exterior of the portion cup or container.

Referring to FIGS. 1 and 2, one or more dispensing containers 102 are preferably provided in the retail or point-of-sale location (FIGS. 1 and 2 show multiple containers 102). Each container contains exclusions (edible toppings, particulates or other ingredients) that the customer may select to be incorporated on or into the surface of that customer's custom chocolate article. Examples of such exclusions include commonly available branded or generic candies, nuts, mini marshmallows and cookie bits, each of which is preferably 1 in. or less in diameter for smaller chocolate articles, although they can be larger in size for larger chocolate articles.

In a preferred embodiment, the dispensing containers 102 are gravity-enabled acrylic bulk candy bins (which may be any suitable shape, including rectangular, spherical, tubular, or any other shape, in any suitable size) that will dispense the customer-specified exclusions into the customer's portion cup or container. This permits the positioning of the gravity-enabled dispensing containers 102 in a convenient location, such as, for example, at or above eye level on a wall or any other suitable location, and allows the customer to view the exclusions through the clear acrylic walls of the dispensing containers 102. In addition, use of gravity-enabled bulk candy containers 102 minimizes product waste and assists in maintaining a safe and sanitary environment.

Once the customer selects the desired exclusions to be incorporated on or into the surface of the customer's custom chocolate article, the operator/employee 123 and/or customer dispenses the customer-specified mix of exclusions into the fixed volume portion cup from the gravity-enabled dispensing containers 102. The fixed volume portion cup ensures that the customer selects no more than the appropriate volume of exclusions to be incorporated on or into the surface of the customer's custom chocolate article.

As will be discussed further below, the operator/employee 123 pours the contents of the customer's fixed volume portion cup or container containing the customer-selected exclusions into a hopper 121 of an exclusion depositor 120 for subsequent distribution across the surface of the custom chocolate article. Because the chocolate is liquid when the exclusions are deposited, some of the exclusions may wholly or partially sink into the chocolate, depending on the size and weight of the exclusions and the relative density of the chocolate. In the preferred embodiment, the operator/employee 123 then may remove the adhesive-backed portion of the duplicate receipt (with unique identifier) from the fixed volume portion cup or container containing the customer-selected exclusions and may place the adhesive backed duplicate receipt onto a single-use chocolate article mold 110 to facilitate that mold being identified with that particular customer's order. The single-use mold 110 contains one or more cavities that correspond to and form the desired shape of the chocolate article. In a preferred embodiment, the cavity is dimensioned to hold approximately 2 oz. of liquid chocolate, and the chocolate article is preferably formed into a rectangular bar of corresponding size, e.g., 7¼ in.×4⅛ in.×¼ in. The cavity or cavities in the single-use mold 110 and the corresponding chocolate article, however, can be any desired shape and size, such as, for example, rectangular, round, triangular, or any other desired shape, including for example any novelty shape such as animals, cars, holiday shapes, etc. The single-use mold 110 is preferably made from plastic, such as polyvinyl chloride (PVC), polyethylene terephthalate (PET, PETE or PETG), or other food-safe material, and is relatively thin as compared to, for instance, durable reusable molds typically used in mass chocolate production of molded articles. For example, the single-use mold 110 may have a thickness in gauges ranging from approximately 0.010″ to 050″ depending on the size of the mold. As explained further below, the single-use mold 110 is provided along with the finished custom chocolate article to the customer. In alternative embodiments the single-use mold 110 may be made of a lightweight and food-safe metal or alloy such as aluminum or tin.

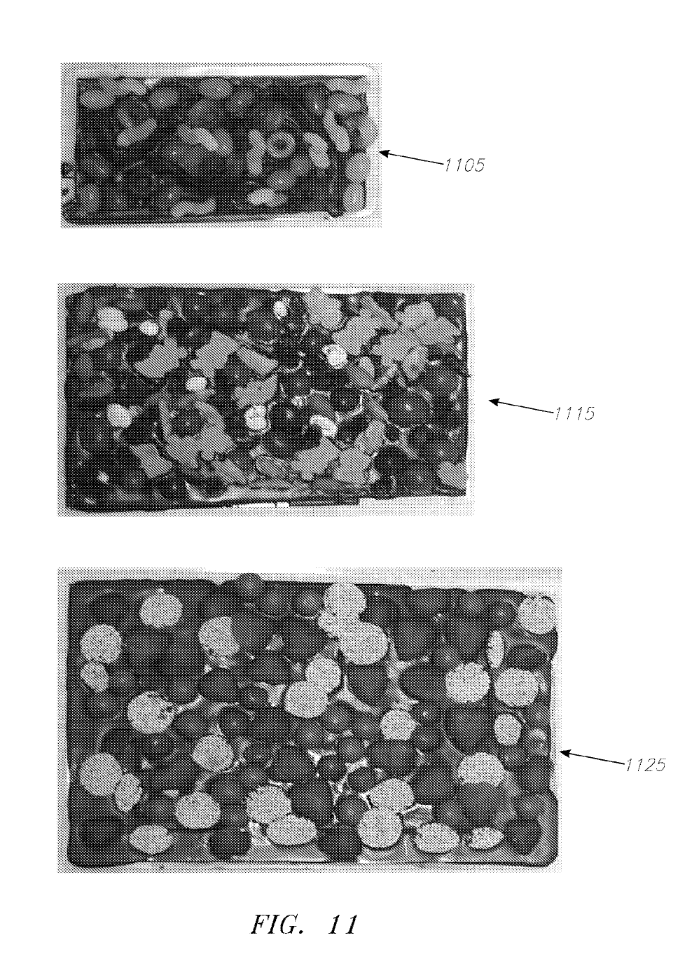

In certain embodiments, the operator/employee 123 may select a single-use mold 110 from among a plurality of different sizes, e.g., small, medium or large, thereby allowing further customization of the chocolate article. In such a case, the customer may be provided with an exclusion portion cup of appropriate size to match the particular single-use mold. In other embodiments, the single-use mold 110 may be divided into two or more sections, with each section capable of receiving a different type of chocolate—for instance, one section may receive dark chocolate, while another may receive milk chocolate, as selected by the customer and/or operator/employee 123. For purposes of illustration, FIG. 11 shows an example of three different sized completed chocolate articles 1105, 1115 and 1125 resulting from three different sized molds spanning a range of approximately 7″ to 15″ in length. By way of example and not limitation, the smallest chocolate article 1105 may be formed from a single-use mold having a cavity measuring approximately 6¾ in.×3½ in.×⅜ in., be filled with approximately 2 ounces of liquid chocolate, and may be topped with approximately 4 ounces of exclusions; the medium-sized chocolate article 1115 may be formed from a single-use mold having a cavity measuring approximately 11 in.×6 in.×½ in., may be filled with approximately 12 ounces of liquid chocolate, and may be topped with approximately 16 ounces of exclusions; and the largest chocolate article 1125 may be formed from a single-use mold having a cavity measuring approximately 15 in.×9 in.×¾ in., may be filled with approximately 26 ounces of liquid chocolate, and may be topped with approximately 28 ounces of exclusions; although in each case the resulting chocolate article 1105, 1115 or 1125 may be slightly larger than the mold cavity due to the presence of a lip or flange around the edges of the single-use mold and, with respect to the vertical dimension, the additional height from any exclusions on the surface of the chocolate article.

In alternative embodiments, rather than use of an adhesive sticker, the single-use mold 110 may be pre-stamped with an identifier (e.g., number and/or bar code), thus providing a similar way to identify the single-use mold 110 and associate it with a particular customer. Also, rather than providing the customer with a portion cup for the exclusions, the operator/employee 123 may dispense the exclusions into the portion cup or, in a more highly automated version of the system, may provide the customer's exclusion selection to an automated control system which, in turn, deposits the appropriate amount of exclusions into the hopper 121 automatically from the appropriate container 102. The automated control system may have any suitable interface, including a touchscreen, keyboard set of buttons, knobs, levers, mouse, joystick, laser pointer, or any other means for inputting data or manually entering information into an automated system.

Referring to FIGS. 1 and 2, a preferred method, system and apparatus is automated and includes a conveyor system to carry the molds through the various components of the system and apparatus. The conveyor system preferably includes one or more continuously moving or operator controllable conveyor belts preferably made from a food-safe durable material that are driven by one or more electric motors and drive systems. Conventional conveyor systems are well known in the art and include continuous, closed or endless conveyors. Specific conveyors are described in more detail below, although in certain more limited embodiments some or all of the conveyors may be eliminated, and the operator/employee 123 may move the single-use mold 110 from station to station rather than requiring a conveyor. In such a case, the operator/employee 123 may, if desired, use a plate or tray (such as a corrugated plastic or CorroPlast® plate) beneath the single-use mold 110 when moving it to provide added support and prevent spillage.

Once the adhesive-backed portion of the duplicate receipt (with unique identifier) is placed on the single-use mold 110, the operator/employee 123 then places the mold 110 on a locator on a first conveyor belt 105. The locator is utilized to ensure that the mold is properly positioned on the conveyor belt 105. The locator may be a holder or fixture affixed to the conveyor 105 into which the mold is placed, locating pins fixed to the conveyor that cooperate with corresponding openings in the mold (or vice versa), or other conventional means for positioning molds (or other items) on a conveyor.

The conveyor 105 carries the single-use mold 110 bearing the unique identifier to a chocolate depositing or dosing station 112. The chocolate depositing or dosing station 112 contains one or more tanks 115 for storing tempered liquid chocolate. In a preferred embodiment, the chocolate depositing or dosing station 112 contains a first tank for storing a suitable amount (e.g., approximately 44 lbs. (20 kilos)) of tempered dark chocolate and a second tank for storing a suitable amount (e.g., approximately 66 lbs. (30 kilos)) of tempered milk chocolate, although, as noted elsewhere, more than two chocolate tanks of may be utilized. Each tank 115 is temperature regulated and preferably agitated to temper the chocolate contained therein. The construction of a suitable chocolate tempering and storage tank is considered within the purview of one skilled in the art and may be similar, for instance, to commercial tanks made by Selmi s.l.r. of Cuneo, Italy, and sold under trade names such as Color™, Future™ or Plus™. In a preferred embodiment, the chocolate reaches a tempered state between about 86° F.-90° F. (30° C.-32° C.). However, the specific tempering process employed—that is, the temperature regulation and agitation speed utilized to ensure that the chocolate contained within the tank 115 forms an appropriate amount of stable crystals—is well known in the art and is dependent for example upon the particular chocolate being utilized and the volume of chocolate in the tempering tank.

The chocolate depositing or dosing station 112 may comprise one or more depositing or dosing heads for depositing tempered, liquid chocolate in predetermined volumes into the mold cavity of the single-use mold 110. One or more precision depositing pumps may be used to pump the desired liquid, tempered chocolate from the tempering tank 115 to the depositing or dosing head when the mold cavity carried by the conveyor 105 is positioned below the dosing head. Conventional techniques, such as the use of sensors, may be utilized to control the timing of the pumps when the mold cavity of the single-use mold 110 is positioned below the dosing head. In a preferred embodiment, the operator/employee 123 selects the particular tank 115 from which the chocolate will be pumped based on the customer-specified preference, and the appropriate amount (e.g., 2 oz.) of tempered liquid chocolate is preferably deposited into the mold cavity. The selection may be made manually or else may be entered into the automated control system previously described.

Where two different chocolate types are desired in the same chocolate article, the single-use mold 110 may be moved to each dosing head in succession, as it would in the case of a single-chocolate-type article. The different types of chocolate may be deposited sequentially in the same mold cavity, or else the dosing heads may be placed close enough together so that they can simultaneously deposit the different chocolates together into the same mold cavity. The different chocolate types may be physically mixed together after being deposited in the mold, either manually using a skewer, fork, whisk or other utensil or else automatically with a retractable member having similar qualities. Where a divided mold is used, the different types of chocolate may likewise be deposited sequentially or, if the dosing heads are close enough together, simultaneously. Where more than two types of chocolates are available, there may be, for example, three (or more) dosing heads in succession, or else three (or more) dosing heads clustered together so that operation of any one or more of them deposits chocolate into the single-use mold. For divided mold cavities, there may be two separate clusters of dosing heads, one cluster positioned over each cavity section of the single-use mold. The dosing heads may be retractable (e.g., on a retractable arm), so that each dosing head is extended over the conveyor when needed and retracted when not in use. In certain embodiments, a single dosing head may dispense multiple different types of chocolate, with different pumps feeding into the dosing head being selectively activated based on the desired chocolate types.

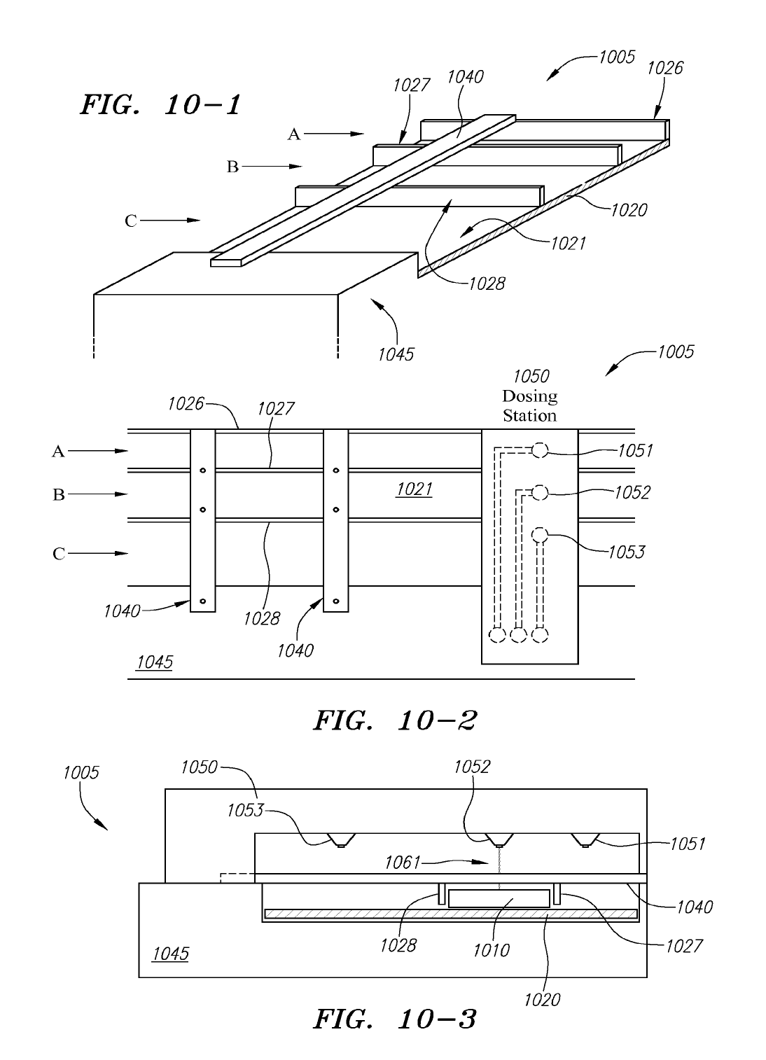

In one embodiment conducive to the use of different sized chocolate molds, multiple conveyor “tracks” are provided with each track corresponding to a different size mold, and in such a case the chocolate dispensing or dosing station 112 may be configured to provide chocolate dosing on any of the tracks. FIGS. 10-1 through 10-3 illustrate one possible example of a multi-track conveyance system 1005 and corresponding dosing station. FIG. 10-1 shows an oblique view of the multi-track conveyance system 1005, with tracks of different sizes labeled “A”, “B” and “C” in order from smallest to largest in width. The smallest mold 110 would be placed on the smallest track (“A”), the medium size mold 110 on the mid-sized track (“B”), while the largest mold 110 would be placed on the largest track (“C”). A single conveyor belt 1020 may be used to transport any of the molds 110 in any of the tracks, although alternatively three different conveyors may be used, one for each track. The multi-track conveyance system 1005 may be constructed in a variety of ways; in this particular example, as illustrated both in FIG. 10-1 and the top view in FIG. 10-2, a plurality of acrylic track guides 1026, 1027 and 1028 and the interior wall of the countertop, platform or table area 1045 of the particular appliance form the side boundaries of, in this case, three tracks A, B and C. Crossbeam supports 1040 are secured to the track guides 1026, 1027 and 1028 as well as anchored to the countertop, platform or table area 1045, as illustrated in FIGS. 10-1 and 10-2 as well as in FIG. 10-3, which shows a cross-sectional view of the multi-track conveyance system 1005. The crossbeam supports 1040 may be secured to the track guides 1026, 1027 and 1028 and to the countertop, platform, or table area 1045 by screws, industrial adhesive, clips, or any other suitable means. The two interior track guides 1027, 1028 are suspended slightly above the top surface 1021 of the conveyor belt 1020, so that the conveyor may move freely beneath them without friction. This design allows a single conveyor belt 1020 to be used for all three tracks A, B and C.

FIGS. 10-2 and 10-3 further illustrate how the dispensing and dosing station 112 may be configured in such a setting. In this particular example, a dosing station 1050 is disposed on or adjacent to the countertop, platform or table area 1045 and may also be supported on the opposite side thereof, along track guide 1026. The dosing station 1050 preferably has a tunnel-like opening directly above the tracks A, B and C so that the conveyor belt 1020 may move the single-use mold 110 underneath one of the dosing heads 1051, 1052 or 1053 of the dosing station 1050. When the mold 110 is positioned beneath one of the dosing heads 1051, 1052 or 1053, the conveyor belt 1020 may be manually halted temporarily, or the presence of the mold 110 may be automatically detected and the conveyor belt 1020 temporarily halted or the forward motion of the mold 110 otherwise impeded (by a retractable gate or latch for instance). The pump for the appropriate dosing head 1051, 1052 or 1053 is then activated for a time period sufficient to fill the cavity in the mold 110; in the particular example shown in FIG. 10-3, dosing head 1052 is shown in the process of dispensing a stream of liquid chocolate 1061 into a medium-sized mold 1010 on track B, the middle track.

The dosing heads 1051, 1052 and 1053 may be sized differently according to the size of the mold 110 that will be filled at the particular station. Where different chocolate types are available, the dosing station 1050 may be duplicated for each chocolate type, or else each dosing head 1051, 1052 and 1053 may be selectively coupled to each of the tanks holding the different types of chocolate. In such a case, activation of the appropriate pump would result in the desired chocolate type being dispensed from the appropriate dosing head 1051, 1052 or 1053. As noted previously, the dosing station 1050 need not be stationary, but for example can be embodied as one or more retractable arms that can be swung and/or pivoted into position above the mold 110. A retractable arm may allow a single dosing head to serve more than one track A, B and C.

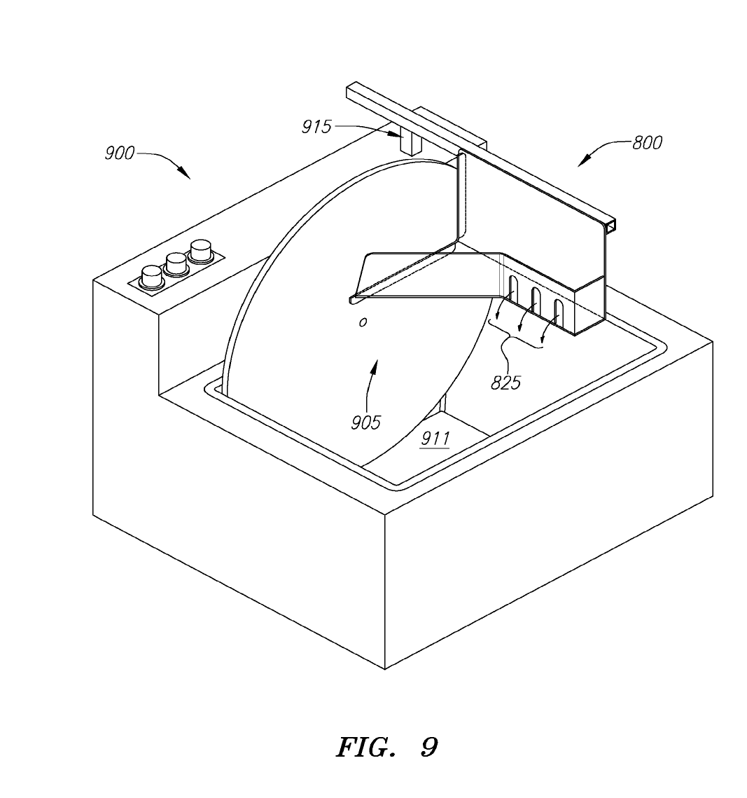

In alternative embodiments, the chocolate depositing or dosing station 112 may make use of a chocolate tempering machine having a spout under which the operator/employee 123 holds a single-use mold 110. An illustration of such a chocolate tempering machine 900 is shown in FIG. 9. In this example, a wheel 905 continuously rotates so as to stir the liquid chocolate, while an agitator (not shown) at the bottom of the chocolate tempering machine 900 also helps stir the chocolate. Chocolate tempering machines such as illustrated in FIG. 9 and constructed with a spinning wheel and agitator are conventionally known in the art. A spout 800 is positioned adjacent to the wheel 905, and is suspended on an arm 915 attached to the base of the chocolate tempering machine 900. As the spinning wheel 905 turns, liquid chocolate adheres to it and circulates with it. As the liquid chocolate reaches the area of the spout 800 adjacent to the wheel 905, some of the liquid chocolate is scraped off at the edges of the spout walls into the trough portion of the spout 800. As the liquid chocolate builds up, it is forced through the trough and eventually out of one or more holes at the end of the spout 800.

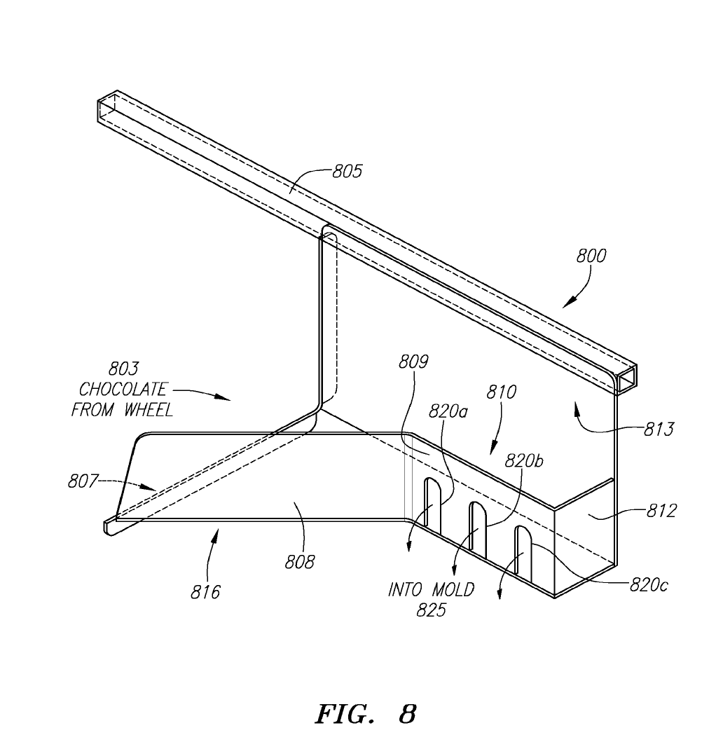

In the particular embodiment mentioned immediately above, the chocolate tempering machine 900 is preferably outfitted with a versatile spout 800 for facilitating the dispensing of liquid chocolate into different sized chocolate molds while achieving relatively even distribution. A more detailed depiction of the versatile spout 800 is shown in FIG. 8. As shown therein, the spout 800 has an extension 805 which may interconnect with a support pole or other mechanism (as illustrated in FIG. 9) for supporting the spout 800. A semi-enclosed trough 810 is surrounded by walls 813, 808, 809, and 812, and by floor 816. The trough 810 is generally wider adjacent to the wheel (shown in relative position in FIG. 9), and narrows to a short end section defined by walls 809, 812, and the forwardmost portion of wall 813. A plurality (in this case, three) of holes 820a, 820b and 820c are formed in wall 809, for allowing the liquid chocolate to be deposited in the cavity of a mold. The spout 800 may be constructed from any material similar to conventional spouts used for the purpose of dispensing chocolate, and may, for example, be constructed of a lightweight, durable, and food-safe material such as PVC plastic or acrylic, or a metal/alloy such as aluminum or stainless steel.

In operation, tempered liquid chocolate circulated by the spinning wheel 905 is scraped off by wall 813 and enters the trough 810 (as depicted by the arrow 803), and gradually builds up and the flow is compressed towards the short end section of the spout 800. Liquid chocolate flows gradually out of holes 820a, 820b, and 820c. The size and spacing of holes 820a, 820b and 820c are preferably matched to the different sizes of single-use molds that are available for use. According to one example of operation in which three mold sizes are available, for a small mold the operator/employee 123 holds the mold under one of the holes 820a, 820b, or 820c, and the flow of liquid chocolate evenly fills the mold. For a medium mold the operator/employee 123 holds the mold under two adjacent holes 820a/820b or 820b/820c, and the flow of liquid chocolate from the two holes evenly fills the medium size mold. For a large mold the operator/employee 123 holds the mold under all three of the holes 820a, 820b, or 820c, and the flow of liquid chocolate evenly fills the larger mold. The spacing of the holes 820a, 820b and 820c is such that the width of the small, medium and large molds matches the appropriate combination. For the small and medium molds, liquid chocolate that does not dispense into the mold cavity, instead simply overflows back into the tank of the chocolate tempering machine 900 and is recirculated. In order to facilitate the dispensing of chocolate using spout 800, the speed of the wheel 905 is preferably slowed down to some degree, generally to between 20 and 30 RPM (depending in part on the viscosity of the chocolate), while the speed of the agitator may be increased to compensate and maintain the proper continued stirring of the liquid chocolate for tempering purposes.

In some cases, the chocolate tempering machine with spinning wheel and agitator may be too small to use a spout of the type illustrated in FIG. 8. In these cases, it may be advantageous for the operator/employee 123 to slow the speed of the wheel down using the machine's standard speed control while filling the mold 110 via a conventional spout, and then returning the wheel to normal speed once the mold 110 has been filled.

After the tempered, liquid chocolate is deposited in the mold cavity of the single-use mold 110, whether by any of the techniques described above, the single-use mold 110 is moved to a vibrating unit 119. For example, the conveyor 105 may carry the single-use mold 110 to a vibrating unit 119, which removes air bubbles and may facilitate even distribution of the tempered liquid chocolate throughout the mold cavity of the single-use mold 110. Alternatively, the operator/employee 123 may move the single-use mold 110 to the vibrating unit 119. It is generally expected that vibrating the mold 110 for 5 to 30 seconds, and generally for 15 seconds or less, will be sufficient for these purposes. Conventional vibrating plates or tables may be utilized in accordance with a preferred embodiment.

The single-use mold 110 is then preferably moved to the vicinity of the exclusion depositor 120. For example, the conveyor 105 may carry the single-use mold 110 containing the tempered liquid chocolate to the exclusion depositor 120. Alternatively, the operator/employee 123 may move the single-use mold to the exclusion depositor 120. As discussed above, in a preferred embodiment, the operator/employee 123 places the contents of the customer's fixed volume portion cup or container containing the customer-selected exclusions into a hopper 121 of the exclusion depositor 120. When the mold cavity of the single-use mold 110 is positioned below the exclusion depositor 120, the depositor 120 preferably vibrates, causing the exclusions contained within the hopper 121 to move toward and through an outlet in the depositor 120. The hopper 121 may in some settings be positioned adjacent to the conveyor, with the outlet either immediately above or to the side of the mold on the conveyor, or else the hopper 121 may be positioned (or moved) directly above the conveyor. As described in more detail below, the hopper 121 may be manually placed over the mold 110 so that it closely surrounds the periphery of the mold 110, or else it may be lowered from an overhead position manually or automatically with, e.g., a hydraulic arm or other assisted mechanism when the mold 110 is properly lined up (as may be detected by mechanical or optical/electronic sensors), and later retracted in a like manner after the exclusions are deposited. The depositor outlet is preferably funnel-shaped, and the depositor 120 distributes the customer-specified exclusions atop the surface of the tempered liquid chocolate contained within the mold cavity of the single-use mold 110. Conventional techniques may be utilized to control the timing of depositing the exclusions when the mold cavity is positioned below the exclusion depositor 120. For example, the speed of the conveyor 105 may be used to determine when the mold cavity is in the appropriate position below the exclusion depositor 120, and/or sensors may be utilized to detect the position of the mold cavity below the exclusion depositor 120. Alternatively, the operator/employee 123 may either move the single-use mold 110 to the appropriate location adjacent to or beneath the exclusion depositor 120, and may trigger the operation of the exclusion depositor 120 to commence depositing the exclusions.

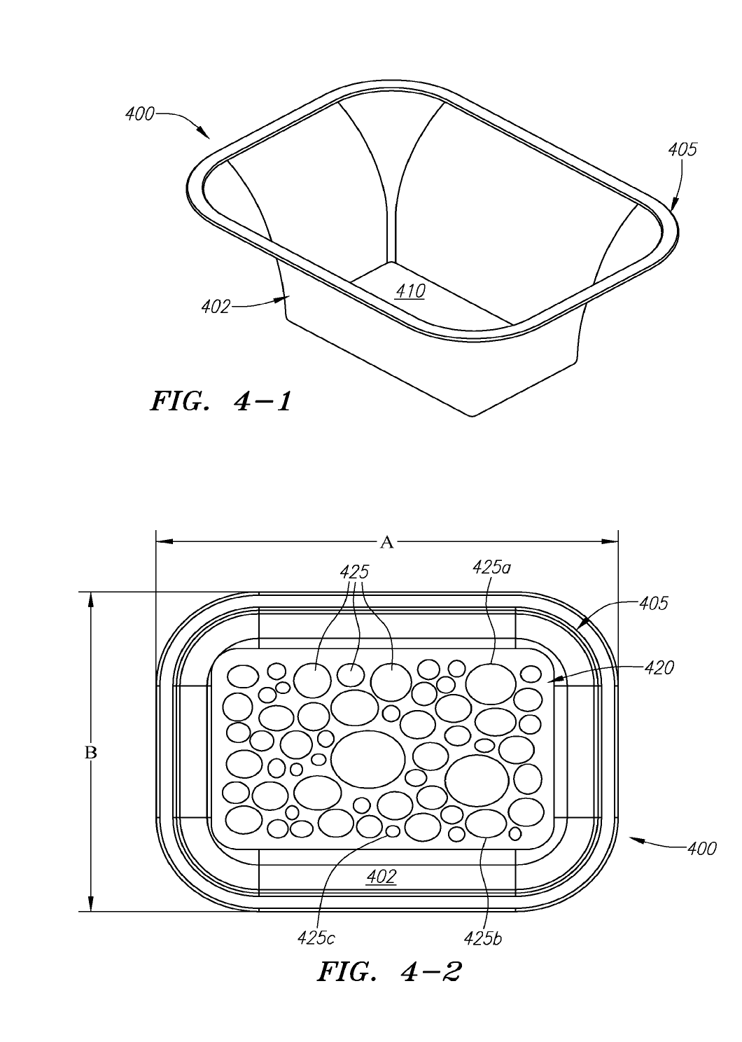

An example of a hopper 121 that may be used in connection with the various custom chocolate article manufacturing processes as described herein is illustrated in FIGS. 4-1 and 4-2. FIG. 4-1 is an oblique view diagram of the uniquely designed hopper 400 for distributing exclusion food products atop a custom chocolate article, and FIG. 4-2 is a top view diagram of the hopper 400 showing a filtering tray or grate 420 with a pattern of holes 425 for allowing the exclusion food products to sift through for even placement atop a custom chocolate article. The hopper 400 in this example has a generally rectangular or box-shaped bottom section 402, gradually tapering outwards in a generally rectangular funnel shape to a top opening that is circumscribed by an upper rim or lip 405. The “corners” of the rectangular bottom section 420 are preferably, but need not be, rounded.

The hopper 400 and grate 420 are preferably formed of a lightweight, durable, and food-safe material such as PVC plastic, although they could alternatively be formed of a lightweight durable metal/alloy such as aluminum or stainless steel. In operation, exclusions are either dropped manually or else can be deposited automatically (if the exclusion containers 102 are located proximate the hopper 121 or 400) into the top opening of the hopper. In an automatic system, the exclusions may be selected, either by the customer or the operator/employee 123, through a user interface of the type mentioned previously (e.g., touchscreen, keyboard, etc.), and the appropriate amount of exclusions may be dropped from the selected exclusion container 102 into the hopper 121 of the exclusion station 120. The appropriate amount of exclusions may be automatically measured by a weight sensor or else mechanically by a rotating compartment beneath the exclusion containers 102, similar to a conventional food/candy vending machine that has a manually rotatable knob or performs a similar function automatically. The hopper 121 may be of any suitable size; for example, with particular reference to the unique hopper 400 of FIGS. 4-1 and 4-2, the hopper 400 may be approximately 13 inches by 9.75 inches around the upper rim 405, tapering down to a base dimension slightly smaller than dimensions of the single-use mold 110. Since vibration of the hopper 400 will cause it to move slightly with respect to the underlying mold 110, even though the base dimensions may be slightly smaller than the mold dimensions, the exclusions will still be deposited across all of the surface area of the liquid chocolate. The dimensions of the grate 420 are likewise to be any suitable dimensions, and preferably are in between the dimensions of the top opening (of the upper rim 405) and bottom opening, so that the grate 420 may be manually dropped into place from the top such that it securely rests somewhere above the bottom opening of the bottom section 402 of the hopper 400. The interior walls of the bottom section 402 of the hopper 400 may have small grooves, extensions or a lip (not shown) to help hold and stabilize the grate 420 in the appropriate position. The grate 420 is preferably positioned sufficiently above the bottom opening of the bottom section 402 of the hopper 400 so that the hopper 400 may be placed completely over and closely surrounding the mold 110, with the bottom section 402 of the hopper 400 overlapping the sidewalls of the mold 110 by, for example, ⅛″ to ¼″. By closely surrounding the mold 110 with the base section 402 of the hopper 400 in an overlapping manner, exclusions may be prevented from falling over the edges of the mold 110 and onto the conveyor.

As noted, the hopper 121 (which may be embodied as hopper 400) is vibrated to facilitate the deposit of exclusions onto the liquid chocolate in the mold 110. If the hopper 121 is positioned directly above the conveyor 105, then mechanical supports or arms may be used to suspend the hopper 121 above the conveyor 105, and may be positioned for example underneath the upper lip 405 of hopper 400, or else a rectangular-shaped frame may be provided with an opening sized to allow the hopper 400 to drop in so that the frame supports the hopper 400 by the upper lip 405 and/or snugly holds the upper walls of the hopper 400. Other alternative means for hold the hopper 121 above or proximate to the mold 110 may also be employed. The vibrating time can be pre-established, and may be triggered by manual operation of the operator/employee 123 or else can automatically triggered by detection of the presence of single-use mold 110 beneath the hopper 121, using any type of suitable sensor. The mold 110 may be held in position temporarily through a mechanical gate, or else the portion of conveyor 105 running next to the exclusion depositor 120 may be temporarily halted during the exclusion depositing process. Where different sized molds 110 are utilized, the system 100 may be configured with multiple exclusion depositors 120 each having a hopper 121 sized to match a given mold size. In automated or semi-automated systems, the size of the mold 110 may be detected as the mold 110 approaches the exclusion depositor(s) 120 and the mold 110 then may be routed to the appropriate station, or else the system 100 may be configured with multiple “tracks” or conveyors 105 running in parallel, one for each mold size, and each having an appropriately sized exclusion depositor 120.

Returning to the preferred hopper 400 and grate 420 shown in FIG. 4-2, the holes 425 within the grate 420 are preferably of different sizes and/or shapes, and are also preferably distributed across the surface area of the grate 420 in a pattern that provides an approximately even spread of exclusions of different sizes/shapes over the mold containing the liquid chocolate. The pattern of holes 425 may be a semi-repeating pattern or else, as illustrated in FIG. 4-2, may have a random appearance. In this particular example, the holes 425 are generally either round or elliptical (oval) in shape, and FIG. 4-2 illustrates a variety of different sized and shaped holes 425 distributed over the surface area of the grate 420. For example, hole 425a is generally of a larger size of nearly circular shape, allowing either large or small exclusions to fall through to the mold. Hole 425b is generally of a medium size and oval shape, allowing medium to small exclusions to fall through to the mold. Hole 425c is generally of a smaller size and approximately circular in shape, allowing only the smallest sized exclusions to fall through to the mold. The solid portions of the grate 420 surrounding the pattern of holes 425 will prevent some exclusions from initially falling directly onto the tempered liquid chocolate in the mold 110 and then, as a result of subsequent vibration, facilitates even distribution over the surface area of the chocolate. Among other things, this action may help prevent clumping of exclusions in a particular region of the liquid chocolate within the mold 110. Thus, when the hopper 400 is vibrated as, or after, the exclusions are placed in the hopper 400, the vibrating motion will cause the holes 425 to move slightly across the area of the mold 110, while exclusions that are blocked by the solid part of the grate 420 are gradually shifted towards the holes 425 and deposited, thereby generally ensuring that all areas of the surface of the tempered liquid chocolate in the mold 110 will have the opportunity to receive some exclusions, and improving the apparent random distribution of exclusions over the final chocolate article. Also, as noted below, even distribution of the exclusions may enhance or facilitate an even cooling process of the liquefied chocolate.

While in the present example of FIGS. 4-1 and 4-2, the hopper 400 is illustrated with a generally rectangular funnel shape, it will be appreciated by those skilled in the art that other shapes and configurations may be used as well. Thus, for example, the hopper 400 may be square, circular or oval in shape, and in such a case the filtering tray or grate 420 would be matched in shape appropriately to fit in the particular hopper shape. Likewise, the holes 425 within the grate 420 may be of different sizes or shapes (e.g., square, rectangular, or other polygon) than those shown in FIG. 4-2, without departing from the overall purpose of the hopper 400 and grate 420 configuration.

Once the exclusions are deposited, the single-use mold 110 containing the tempered chocolate with exclusions may optionally be carried by a conveyor to a vibrating plate or table (not shown) to ensure that the exclusions are evenly distributed over the surface of the chocolate within the mold cavity. Alternatively, as already explained, the exclusion depositor 120 may be configured to vibrate or otherwise move to evenly distribute the exclusions across the surface of the chocolate contained within the mold cavity of the single-use mold 110.

To line up the mold 110 with the hopper 121 in an automated or semi-automated system, according to one embodiment, a mechanical latch or gate may stop the forward motion of the mold 110 and cause the conveyor to stop temporarily. The latch or gate may then retract, allowing a pair of flat retractable plungers located on each wall of the track to be moved towards each other slightly to align the mold, then retract leaving it in properly aligned position. The hopper 121 may then be lowered from an overhead position, so that the base of the hopper 121 fully surrounds the mold 110 while the exclusions are deposited. The hopper 121 may remain in that position while the mold is vibrated, and then may be removed from the mold 110 and returned to its stationary position. Alternatively, in a simpler embodiment, the guiding sidewalls (such as 1026, 1027 and 1028 in FIGS. 10-1 and 10-2) may be used to maintain alignment of the sides of the mold 110, and the height of the sidewalls may drop down to a low height (e.g., ¼″) in the area of the exclusion depositing station. The hopper 121 may then be lowered above the mold 110 and fully surround it so long as the mold 110 is higher than the height of the track sidewalls at the exclusion station.

Examples of chocolate articles showing potential distributions of exclusions are illustrated in FIG. 11, which shows small, medium and large chocolate bars 1105, 1115, and 1125 respectively with different types of exclusions distributed in different patterns.

After the customer-selected exclusions are deposited over the surface of the chocolate contained within the mold cavity, the single-use mold 110 is preferably carried by a conveyor (which may be a continuation of conveyor 105 in a more fully automated system, or may be a separate conveyor) through at least one cooling tunnel 125, 130 and/or 135 to cool and solidify the tempered chocolate. The portions of the conveyor 105 traveling through the cooling tunnel(s) 125, 135 and/or 140 may have a flexible wire/metal mesh belt, so that the coolness of the metallic conveyor belt facilitates the cooling of the underside of the single-use mold 110. As more than one mold 110 with tempered liquid chocolate can be processed simultaneously in the overall system 100, the example in FIG. 1 shows for illustrative purposes a second mold 110A at the start of cooling tunnel 125. In a preferred embodiment, a first cooling tunnel 125, a spiral conveyor enabled cooling unit 135 and a second cooling tunnel 140 are utilized to rapidly cool and solidify the tempered chocolate within a relatively short amount of time as compared to conventional mass chocolate production, preferably within approximately 8 to 12 minutes, which is substantially less than conventional cooling times, and thus may be configured so that the mold 110 spends approximately 8 to 12 minutes collectively within the cooling tunnel(s) 125, 135 and/or 140.

The first and second cooling tunnels 125, 140 and the spiral conveyor enabled cooling unit 135 may utilize convective cooling from one or more compressors to cool ambient air within each tunnel and the cooling unit to a temperature sufficient to rapidly cool the chocolate article, preferably within the range of about 50° F. to 58° F., and more preferably about 55° F. (13° C.), while maintaining a sufficiently low relative humidity of less than about 55% and more preferably about 50% or less. Fans (e.g., 129, and as illustrated conceptually by fan symbols in FIG. 1) located within each cooling tunnel 125, 140 and within the spiral conveyor enabled cooling unit 135 are preferably employed to circulate the cooled ambient air to cool and solidify the custom chocolate article within the mold 110.

As illustrated in FIGS. 1 and 2, the first and second cooling tunnels 125, 140 may be separated by the spiral conveyor enabled cooling unit 135 through which the single-use mold 110 passes to further cool and solidify the custom chocolate article within the mold 110. One advantage of using the spiral conveyor enabled cooling unit 135 is its space saving characteristics, which results in a substantially smaller footprint for the system and apparatus disclosed herein. After passing through the first cooling tunnel 125, the mold 110 preferably continues through the spiral conveyor enabled cooling unit 135 and into the second cooling tunnel 140 to further cool and solidify the custom chocolate article in the mold 110. Besides saving space, the combination of straight and spiral cooling tunnels 125, 135 and 140 may provide visual interest to customers who are watching the custom chocolate article being made while they wait. The cooling tunnels 125, 135 and 140 may be configured with transparent acrylic covers (e.g., acrylic cover 126 over the first cooling tunnel 125) to allow customers to actually view the chocolate products as they travel on the conveyor within the cooling tunnel. Other cooling tunnel configurations may also be used—for example, a single straight cooling tunnel, or a circular or semi-circular cooling tunnel, or even a “figure 8” cooling tunnel in which the mold 110 enters and exits on opposite sides of the cooling tunnel, or any other desired configuration. For longer cooling tunnel configurations, the conveyor speed may be increased in order to maintain the target cooling time, for example 8 to 12 minutes.

Several factors may combine in order to provide a substantially shorter cooling time than is conventionally possible in, for example, mass chocolate production. First, the cooling tunnel temperature and humidity are preferably chosen so as to provide an optimal cooling time, as noted above. Second, because the chocolate article is made to be consumed by customers shortly after completion or perhaps within a few hours or days, the need for typical shelf stability of 6 to 9 months for mass produced chocolate articles (most retailers, as noted, require an even longer minimum 9 months of shelf life for chocolate bars) is not present. This means that the crystallization of the chocolate can be less stable, e.g., the chocolate can be cooled more quickly, without sacrificing perceived quality, so long as the chocolate is consumed within a relatively short period. It also means that the cooling time can be selected to be shorter without necessarily affecting the end product as perceived by the consumer. In a similar vein, the need for strict graduated temperature control throughout the cooling tunnel may be avoided. Whereas in mass chocolate production, the cooling tunnel is typically “zoned” so that the temperature gradually falls off to the lowest cooling temperature, then gradually ramps up back to the ambient temperature outside the cooling tunnel, in embodiments of the chocolate article manufacturing system disclosed herein the cooling tunnel need not be zoned but rather can be maintained at a single low temperature (falling within the range of, e.g., about 50° F. to 58° F.) throughout. Consequently, when the mold 110 enters the cooling tunnel(s), it is immediately exposed to a relatively low temperature, rather than experiencing only a slight temperature drop as is commonplace in cooling tunnels used for mass chocolate production. In addition, unlike molds used in conventional mass chocolate manufacturing that must be durable for multi-use and significantly thicker, the walls of the single-use mold 110 can be made relatively thin, since the mold 110 does not need to be durable for reuse, so that the cool air within the cooling tunnel(s) can penetrate more rapidly. The fact that the single-use mold 110 generally holds a single chocolate article (possibly sectioned however) means that the liquid chocolate has more area exposed to the cool air due to the fact that it is surrounded on all sides by the thin walls of the mold 110. By contrast, in mass chocolate article manufacturing, a mold often contains many cavities for chocolate, often arranged in rows, and the warm liquid chocolate in the outer cavities insulates the inner cavities, requiring more cooling time to ensure that all chocolates are cooled down as necessary. In addition, in a preferred system, use of a flexible mesh/metal conveyor belt within the cooling tunnels can help dissipate heat from the underside of the mold 110, due to convective action and the coolness of the mesh/metal, and holes in between the mesh links can additionally help expose the underside of the mold 110 to the cool air within the cooling tunnel(s). Placing the exclusions at room temperature across the tempered liquid chocolate in the mold 110 also has the immediate effect of partially cooling the liquid chocolate. By contrast, in a mass chocolate production settings, ingredients are often combined with the chocolate at similar temperatures so as not to disrupt the crystallization process, which otherwise might risk the intended long shelf life of the article. When the mold 110 exits the cooling tunnel(s), it is placed into a package, as described below, instead of necessarily needing to be fully solidified to allow removal from the mold. Some or all of these factors may be used in combination to achieve a rapid cooling time.

The overall length(s) of the cooling tunnel(s) is preferably chosen so that the mold 110 remains within the cooling tunnel for the appropriate time period. For example, where the conveyor moves through the cooling tunnel(s) at one foot per second, the total length of the cooling tunnel(s) may be selected to be 10 feet, for a total cooling time within the tunnel(s) of 10 minutes. If the conveyor moves slower, a shorter cooling tunnel may be used, and if it moves faster a longer cooling tunnel may be used. The cooling tunnel(s) may have small openings on either end that may correspond to the single-use mold sizes to help insulate the interior from the ambient outside air, and/or may have automatic doors which, upon sensor detection of an approaching mold 110, temporarily open to allow the mold 110 to pass into the cooling tunnel, thereby minimizing the outflow of cool air and the inflow of ambient warmer air into the cooling tunnel.

In a preferred embodiment, the second cooling tunnel 140 terminates in a funnel-shaped ramp or chute 142 that feeds the single-use mold 110 containing the custom chocolate article into a box, container or other packaging. The operator/employee 123 then may remove the completed packaging from the end of the ramp or chute 142 and either places the packaging in a temperature-controlled display case 150 or gives it to the waiting customer. The operator/employee 123 may remove the adhesive sticker from the mold 110 and place it on the box, container or other packaging. Alternatively, the mold 110 may be boxed after it exits the cooling tunnel(s) by an automatic packaging machine (not shown), which may be of any conventional design and which are generally commonplace in food processing manufacturing plants or facilities. The automatic packaging machine may be relatively simple and small, or else in more elaborate settings may be larger and capable of packaging multiple chocolate articles at a time. The boxes used for packaging may have a clear (e.g. cellophane) window positioned where the adhesive sticker or other identifying indicia appears on the mold 110, so they can be readily identified by the customer and/or the operator/employee 123.

In a preferred embodiment, various components of the system and apparatus may be encased or windowed in acrylic or similar transparent material to allow customers to view the various stages of the manufacturing process. For instance, the exclusion depositor 120, spiral cooling unit 135, cooling tunnels 130, 140 and funnel-shaped ramp or chute 142 may be encased in acrylic or similar transparent material. In addition, one or more digital cameras (such as a fiber optic snake camera conventionally available for surveillance) may be used in various parts of the system to allow customers to view the chocolate article manufacturing process on a nearby display screen. For example, one or more digital cameras may be positioned so as to view within the cooling tunnel(s), so that customers may watch the chocolate article during the cooling process, thereby increasing the interactive customer experience.

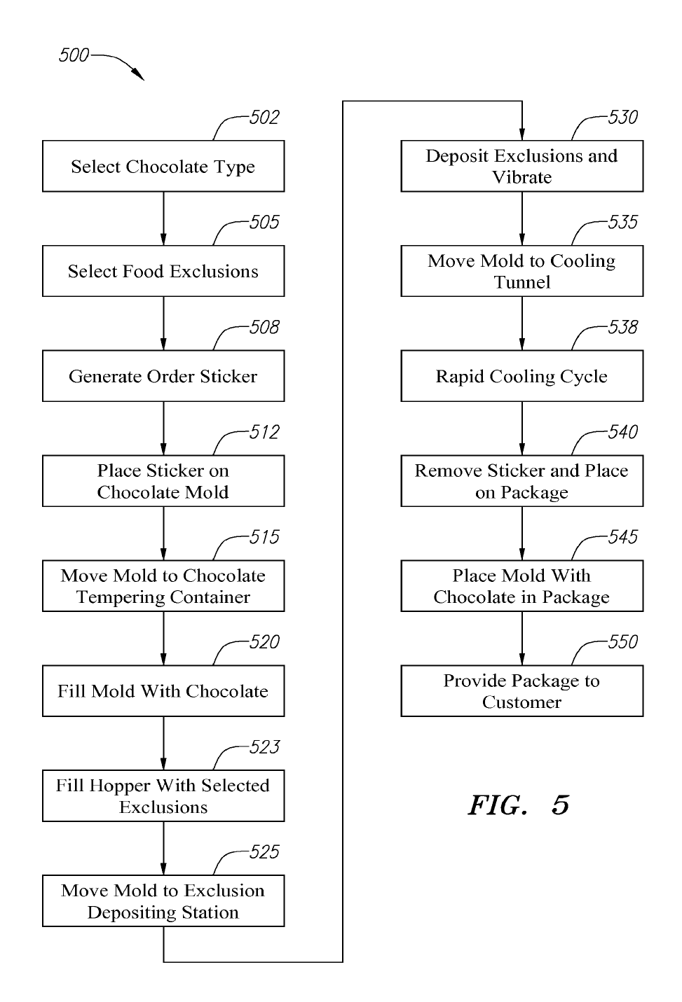

Many variations of the aforementioned sequence of processing steps may be envisioned by those skilled in the art. Several such variations are illustrated in more detail by the process flow diagrams of FIG. 5 through 7. Each of these process flow diagrams will be described in turn, with reference as necessary to the system components illustrated in the other accompanying figures.

According first to the process flow diagram illustrated in FIG. 5 pertaining to a general process 500 for manufacturing custom chocolate articles, in a first step 502 the type of chocolate is selected from among a plurality of different chocolate types—e.g., dark (either bittersweet or semi-sweet), milk or white chocolate, or any other type of chocolate that is provided. Optionally, this step 502 may be omitted where only one type of chocolate is available in the system. The chocolate type(s) may be selected by inputting customer selections via a user interface into an automated processing system or POS device such as an electronic register, or else may simply be recorded by the operator/employee 123 in a more manual process. Similarly, the customer selection of the size of the chocolate article (e.g., small, medium or large) may also be inputted or recorded, where different bar sizes are provided.

In a next step 505, one or more exclusions are selected from among the plurality of exclusions in the various containers 102. Similar to the chocolate selection, the exclusions may be selected by inputting customer selections via a user interface into an automated processing system or POS device, or else may be recorded by the operator/employee 123 in a more manual procedure. Optionally, the customer may be provided a portion cup or container to be filled from one of the exclusion containers 102 as previously described. In a more automated system, the automated processing system may cause the exclusions to be automatically measured and deposited into the hopper 121 of the exclusion depositor 120. In such a case the exclusion containers 102 are preferably located in proximity to and above the hopper 121, so that gravity assist may be used in guiding the exclusions into the hopper 121.

In the next steps 508 and 512 of the process 500, an adhesive order sticker is generated and placed on a single-use chocolate mold 110. In alternative methods, the single-use mold 110 may be pre-marked with identifying indicia, or else in a more automated setting, the automated processing system may either apply an adhesive sticker to the chocolate mold 110 or automatically read a pre-marked identifier (such as a bar code) from the chocolate mold and thereby associate the mold 110 with the customer's order, entered by the operator/employee 123 (or customer) into a POS device.

In a next step 515, the single-use mold 110 is moved to a chocolate dispensing or dosing station 112 nearby the one or more tanks 115 holding liquid, tempered chocolate 115. The mold 110 may either be conveyed on a conveyor 105 or else manually carried to the chocolate dispensing or dosing station 112. In a more automated system, the appropriate size of mold 110 may be selected from a given stack or collection of molds and dropped or placed onto the conveyor 105 automatically, based on the customer's chocolate article size and type selection as input into the automated processing system. Machinery for placing chocolate molds on a conveyor is conventionally known and is used for example in larger mass chocolate production settings. Alternatively the operator/employee may place the mold 110 onto the conveyor 105. As previously mentioned, the chocolate may be contained in a chocolate tempering machine having a wheel and agitator configuration, whereby the operator/employee 123 may hold the mold 110 underneath a spout (see FIGS. 8 and 9) for filling it with the customer's selected chocolate type. In a more automated system, the mold 110 may be placed on an appropriate conveyor track (if multiple tracks are provided, as described previously with respect to FIGS. 10-2 and 10-3) or else be steered beneath an appropriate dosing head, and/or the appropriate dosing head may be activated by the automatic processing system for a time programmed to fill the given size chocolate mold 110. A digital scale may also be used to provide feedback to the automated processing system, or else to indicate the weight of the chocolate to the operator/employee 123.

In a next step 523, which may be concurrent with some of the preceding steps, the hopper 121 of the exclusion depositor 120 is filled with the customer's selection exclusion type(s). This can be done in a variety of different ways. For example, the operator/employee 123 may take a portion cup or container with the exclusions selected in step 505 and deposit them in the hopper 121 manually. Alternatively, in a more automated system, the exclusions may be automatically deposited into the hopper as previously described. In the latter case, where multiple chocolate articles (and hence molds 110) are being processed simultaneously, a sensor at the exclusion depositor 120 may detect the presence of a mold 110 and read its identifying indicia, and only at that point cause the exclusions to be deposited into the hopper 121. That way, multiple customer selections may be input into the automated processing system in advance while the molds 110 are being processed sequentially.

In next steps 525 and 530, the mold 110 is moved to the exclusion depositor 120 and the exclusions are deposited on the surface of the tempered liquid chocolate in the mold 110, which is vibrated to remove air bubbles and their distribution onto the liquid chocolate. As noted previously, the mold 110 may be automatically conveyed from the chocolate dispensing or dosing station 112 to the exclusion depositor 120, or else it may be manually carried by the operator/employee 123 to the exclusion depositor 120. Before, during or after the exclusion depositing step, the mold 110 may be vibrated (e.g., at vibrating table 119) to remove air bubbles from the liquid chocolate. As also noted previously, the hopper 121 when particularly embodied as the preferred hopper 400 in FIGS. 4-1 and 4-2 may be vibrated to facilitate the deposit of exclusions onto the liquid chocolate. After depositing the exclusions, the hopper 121 may be rotationally pivoted upwards to an upside-down position and back down to normal resting position in order to remove any remaining exclusions that may have been stuck on the grate 820.

After step 530, the single-use mold 110 is moved to the cooling tunnel(s) 125, 135 and/or 140. The mold 110 may be automatically conveyed from the exclusion depositor 120 to the cooling tunnel(s), or else may be manually carried by the operator/employee 123 and placed on a conveyor entering the cooling tunnel(s). From that point on, the mold 110 is preferably automatically conveyed until it exits the cooling tunnel(s) at the end of the cooling process. The rapid cooling cycle process 538 and preferred temperature, timing and other characteristics have already been described in detail above.

After the mold 110 exits the cooling tunnel(s), in next steps 540 and 545, the operator/employee 123 removes the adhesive sticker from the mold 110 and places it on a box, and the place the mold containing the cooled chocolate article within the box. Alternatively, the box may have a clear window at a specified location matching the location of the sticker or other identifying indicia on the mold 110, and in such a case the mold 110 can be placed directly in the box. In a more automated system, as previously described, the chocolate article in the mold 110 can be automatically packaged in the box after it exits the final cooling tunnel.

In a last step 550, the box containing the chocolate article still in the mold may be provided to the customer, or else it may be placed in a temperature-controlled display area 150 for temporary storage.

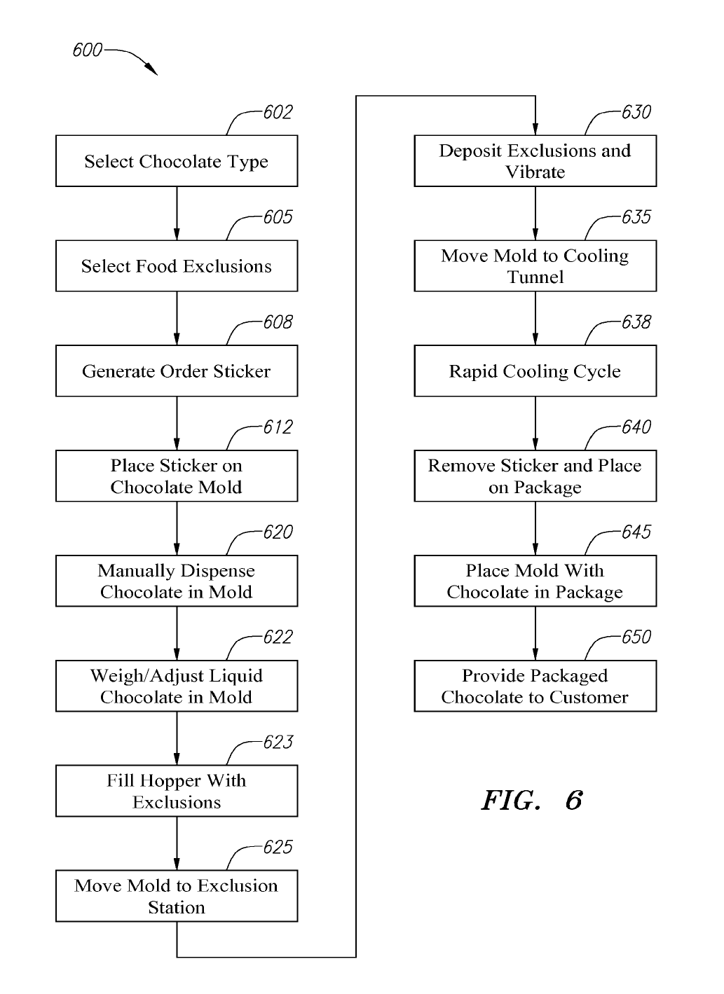

Some of the steps illustrated in FIG. 5 may optionally be omitted, or further steps added, without departing from the scope and spirit of the invention. Likewise, certain steps may be partially or fully automated, or else may be manually carried out, while still remaining within the bounds of the invention. FIG. 6 for instance shows a similar process to FIG. 5 for manufacturing custom chocolate articles but focuses in certain respects on a higher degree of manual involvement. In FIG. 6, in a first step 602 the type of chocolate is selected from among a plurality of different chocolate types—e.g., dark, milk and/or white chocolate, or any other type of chocolate that is provided. Optionally, this step 602 may be omitted where only one type of chocolate is available in the system. The chocolate type(s) may be selected by inputting customer selections into an electronic register or else otherwise be recorded by the operator/employee 123. Similarly, the customer may select a desired size and/or shape (e.g., small, medium or large and/or round, square, triangular, etc.) of the chocolate article, where provided.

In a next step 605, one or more exclusions are selected from among the plurality of exclusions in the various containers 102. Similar to the chocolate selection, the exclusions may be selected in part by inputting customer selections into a POS device or else may otherwise be recorded by the operator/employee 123. Optionally, the customer may be provided a portion cup or container to be filled from one of the exclusion containers 102 as previously described, and may provide the portion cup or container to the operator/employee 123 for placement in the hopper 121 of the exclusion depositor 120.

In the next steps 608 and 612 of the process 600, an adhesive order sticker is generated and placed on a single-use chocolate mold 110. In alternative methods, as previously described, the single-use mold 110 may be pre-marked with identifying indicia, and/or the POS device may read a pre-marked identifier (such as a bar code) from the custom chocolate mold and thereby associate the mold 110 with the customer's order.

In a next step 620, the single-use mold 110 is moved to a chocolate dispensing or dosing station 112 nearby the one or more tanks 115 holding liquid, tempered chocolate 115, and the mold 110 is filled with liquid chocolate. As previously mentioned, the chocolate may be contained in a chocolate tempering machine having a wheel and agitator configuration, whereby the operator/employee 123 may hold the mold 110 underneath a spout (see FIGS. 8 and 9) for filling it with the customer's selected chocolate type. A digital scale may also be used to indicate the weight of the chocolate to the operator/employee 123. If too much chocolate has been added to the mold 110 the operator/employee 123 may adjust the amount of chocolate (step 622) by, e.g., scraping some of the liquid chocolate off and letting it overflow back into the open tank of the chocolate melter.

In next steps 623, 625 and 630, the operator/employee 123 fills the hopper 121 of the exclusion depositor 120 with the customer's selection exclusion type(s) from the portion cup, carries or conveys the single-use mold 110 to the exclusion depositor 120, and deposits the exclusions atop the tempered liquid chocolate in the mold 110. More specifically, according to one particular technique, the operator/employee 123 may move the mold 110 manually (or by conveyor) to the vibrating unit 119, place the hopper 121 over the mold 110, add exclusions to the hopper 121, and activate the vibrating unit 119 to facilitate distribution of the exclusions over the tempered liquid chocolate in the single-use mold 110. While the vibrating unit 119 may also have the effect of removing air bubbles from the tempered liquid chocolate in the mold 110, as noted previously the mold 110 may also be vibrated before or after the exclusion depositing process in order to remove air bubbles.

After the exclusions have been deposited, the single-use mold 110 is moved to the cooling tunnel(s) 125, 135 and/or 140. The mold 110 may be automatically conveyed from the exclusion depositor 120 to the cooling tunnel(s), or else may be manually carried by the operator/employee 123 and placed on a conveyor entering the cooling tunnel(s). From that point on, the mold 110 is preferably automatically conveyed until it exits the cooling tunnel(s) at the end of the cooling process, as previously described. The rapid cooling cycle process 638 and preferred temperature, timing and other characteristics have already been described in detail above.

After the mold 110 exits the cooling tunnel(s), in next steps 640 and 645, the operator/employee 123 removes the adhesive sticker from the mold 110 and places it on a box, and places the mold containing the cooled chocolate article within the box. Alternatively, the box may have a clear window at a specified location matching the location of the sticker or other identifying indicia on the mold 110, and in such a case the mold 110 can be placed directly in the box. In a last step 650, the box containing the chocolate article may be provided to the customer, and/or else it may be placed in a temperature-controlled display area 150 for temporary storage.

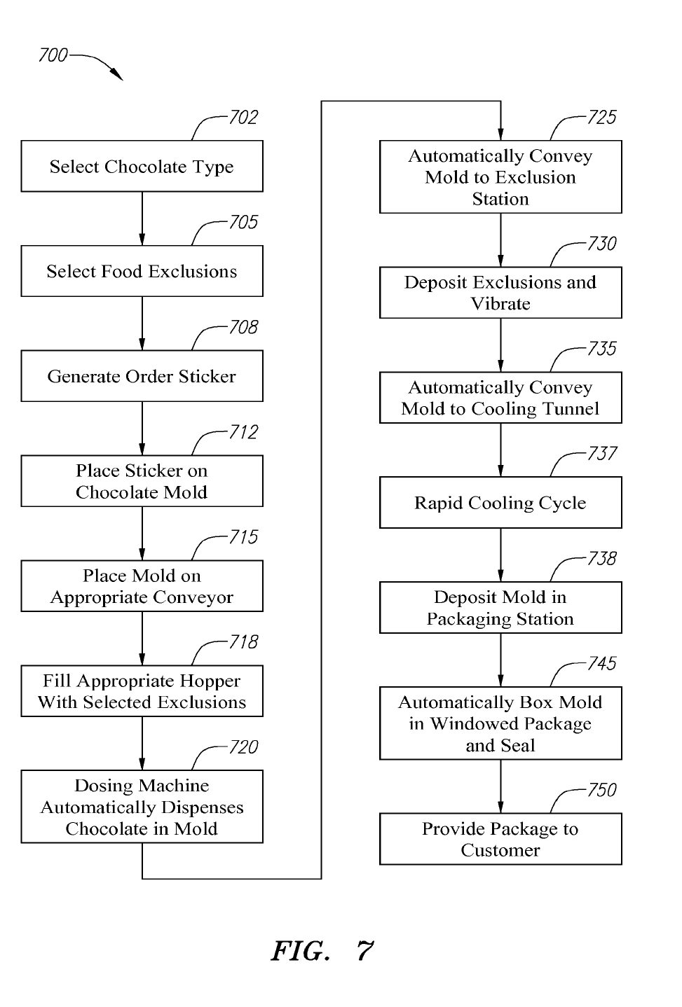

FIG. 7 illustrates another process similar to that shown in FIG. 5, but with greater focus on semi- or fully automated methodologies. According to the process flow diagram illustrated in FIG. 7, in a first step 702, as with the prior processes, the type of chocolate is selected from among a plurality of different chocolate types—e.g., dark, milk and/or white chocolate, or any other type of chocolate that is provided. Optionally, this step 702 may be omitted where only one type of chocolate is available in the system. As noted before, the chocolate type(s) may be selected by inputting customer selections via a user interface into an automated processing system or POS device such as an electronic register. Similarly, the customer selection of the size and/or shape of the chocolate article (e.g., small, medium or large and square, round, triangular, etc.) may also be input or recorded, where different bar sizes or shapes are provided.

In a next step 705, one or more exclusions are selected from among the plurality of exclusions in the various containers 102. Similar to the chocolate selection, the exclusions may be selected by inputting customer selections via a user interface into an automated processing system or POS device. The automated processing system may cause the exclusions to be automatically measured and deposited into the hopper 121 of the exclusion depositor 120. In this case the exclusion containers 102 are preferably located in proximity to and above the hopper 121, so that gravity assist may be used in guiding the exclusions into the hopper 121.

In the next steps 708 and 712 of the process 700, as previously described in connection with the FIG. 5 process, an adhesive order sticker is generated and placed on a single-use chocolate mold 110. In alternative methods, the single-use mold 110 may be pre-marked with identifying indicia, or else the automated processing system may either apply an adhesive sticker to the chocolate mold 110 or automatically read a pre-marked identifier (such as a bar code) from the chocolate mold and thereby associate the mold 110 with the customer's order, entered by the operator/employee 123 (or customer) into a POS device.

In a next step 715, the single-use mold 110 is conveyed to a chocolate dispensing or dosing station 112 nearby the one or more tanks 115 holding liquid, tempered chocolate 115. Where different mold sizes or shapes are available, the appropriate size and shape of mold 110 may be selected from a given stack or collection of molds and dropped or placed onto the conveyor 105 automatically, based on the customer's mold type selection as input into the automated processing system. Machinery for placing chocolate molds on a conveyor is conventionally known and is used for example in larger chocolate factory settings. Alternatively the operator/employee may place the selected sized/shaped mold 110 onto the conveyor 105. Each chocolate tempering machine is preferably coupled to at least one dosing head for automatically dispensing the appropriate chocolate type in accordance with the customer's selection when the mold 110 is beneath the dosing head. As previously described, multiple tracks of the conveyor belt may be provided with each track associated with a given chocolate type, or else multiple dosing heads may be clustered above a given track and selectively actuated to dispense the proper chocolate type(s) when the mold is located beneath the cluster of dosing heads. The automatic processing system preferably activates the appropriate dosing head(s) for a time programmed to fill the given size chocolate mold. A digital scale may also be used to provide feedback to the automated processing system, and/or optical or other sensors may be used to detect when the level of the chocolate has reached a given height.

In a next step 723, which may be concurrent with some of the preceding steps, the hopper 121 of the exclusion depositor 120 is filled with the customer's selection exclusion type(s). Although this can be done by the operator/employee 123 filling the hopper 121 manually with the customer's selected exclusions, in the more automated system the exclusions are preferably automatically deposited into the hopper 121 directly from the exclusion containers 102 under control of the automated processing system as previously described. As noted, where multiple chocolate articles (and hence molds 110) are being processed simultaneously, a sensor at the exclusion depositor 120 may detect the presence of a mold 110 and read its identifying indicia, and only at that point cause the exclusions to be deposited into the hopper 121, so that multiple customer selections may be input into the automated processing system in advance while the molds 110 are being processed sequentially.

In next steps 725 and 730, the mold 110 is moved to the exclusion depositor 120 and the exclusions are deposited on the surface of the liquid chocolate in the mold 110, which is vibrated to remove air bubbles and/or facilitate the deposit of exclusions from the hopper 121 and their distribution on/in the liquid chocolate. The mold 110 may be automatically conveyed from the chocolate dispensing or dosing station 112 to the exclusion depositor 120. Before, during or after the exclusion depositing step, the mold 110 may be vibrated (e.g., at vibrating station 119) to remove air bubbles from the liquid chocolate. As also noted previously, the hopper 121 when particularly embodied as the preferred hopper 400 in FIGS. 4-1 and 4-2 may be vibrated to facilitate the deposit of exclusions onto the liquid chocolate. After depositing the exclusions, as also noted previously, the hopper 121 may automatically be rotationally pivoted upwards to an upside-down position and back down to normal resting position in order to remove any remaining exclusions that may have been stuck on the grate 820.

After the exclusions are deposited, the single-use mold 110 is automatically conveyed (step 735) to the cooling tunnel(s) 125, 135 and/or 140, which operate to cool the liquid chocolate with exclusions in a manner previously described. The rapid cooling cycle process 737 and preferred temperature, timing and other characteristics have already been described in detail above.

After the mold 110 exits the cooling tunnel(s), in next step 738 and 745, as previously described, the mold 110 is preferably automatically packaged in a single article box. The box may have a clear window so that the identifier on the mold 110 can be seen. In a last step 750, the box containing the chocolate article may be provided to the customer, or else it may be placed in a temperature-controlled display area 150 for temporary storage.

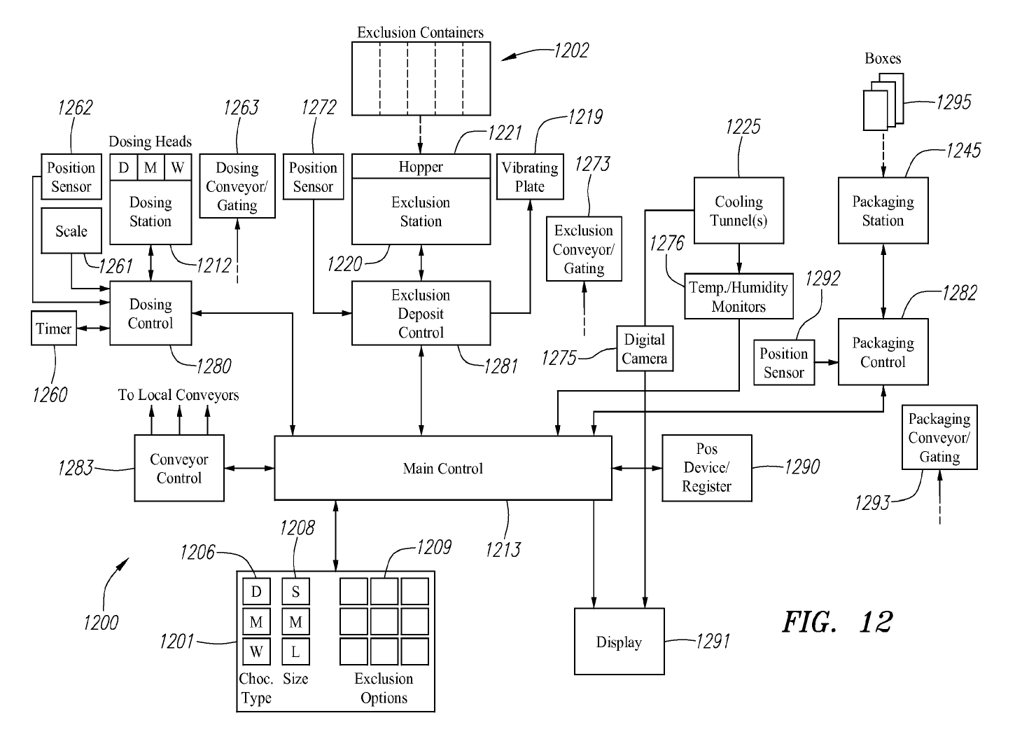

FIG. 12 is a block diagram showing an example of an automated process control system 1200 for controlling the manufacture of custom chocolate articles as may be used in whole or part in connection with various embodiments as disclosed herein. In FIG. 12, a user interface 1201 may allow a customer or operator/employee to indicate selections for the desired chocolate article including, by way of example, a chocolate type (e.g., dark, milk or white), size of mold (e.g., small, medium or large), and exclusion type(s). The illustrated buttons or keys 1206, 1208, 1209 correspond to these options. While the user interface 1201 is shown in a conceptual manner, as noted previously the user interface 1201 may be embodied using any of a wide variety of technologies for receiving input information including, for example, touchscreen, keyboard set of buttons, knobs, levers, mouse, joystick, laser pointer, or any other means for inputting data or manually entering information into an automated system.

The user interface 1201 is coupled to a main controller 1213, which may be embodied as computer or computerized device such as a PC or an embedded control system. The main controller 1213 is in turn coupled to the other components of the automated control system 1200, including a dosing control subsystem 1280, an exclusion depositing control subsystem 1281, a packaging control subsystem 1282, and a conveyor control subsystem 1283, each of which control the operations of a local portion of the overall custom chocolate article manufacturing process or machinery as heretofore described. Thus, for example, the dosing control subsystem 1280 may control the chocolate dispensing or dosing station 1280 and associated dosing heads, along with a position sensor 1262 (for detecting the presence or position of the mold 110, and which may be mechanical or optical/electrical), a digital scale 1261 (for measuring the liquid chocolate in the mold by weight), and/or a timer 1260 (for timing the dosing operation so that the appropriate amount of liquid chocolate is dispensed). The conveyor control subsystem 1283 may control the various sections of the conveyor and associated gating, including the dosing conveyor/gating 1263, exclusion depositor conveyor/gating 1273, and packaging station conveyor/gating 1293, all for the purpose of controlling the forward motion of the mold 110 on the conveyor at the different stations. The exclusion depositing control subsystem may control the exclusion depositor 1220 and associated hopper 1221, the exclusion containers 1202 (so as to automatically deposit exclusions in the hopper 1221 as needed), a position sensor 1272 for detecting the presence or position of the mold 110), and a vibrating plate 1219 (for shaking/vibrating the mold 110 after exclusions are deposited). The packaging control subsystem 1282 may control the automated packaging station 1245 including a box selector where different size boxes are provided, and a position sensor 1292 (for detecting the presence of position of the mold 110). The main controller 1213 may also monitor various parameters from the cooling tunnel 1225, such as temperature and humidity, and may also in certain scenarios send commands to the cooling tunnel 1225 to adjust the temperature and humidity based on the monitored readings. As noted previously, a digital camera 1275 may be provided in the cooling tunnel 1225, and the output therefrom may be transferred to a screen display 1291 in the customer waiting area, so that customers can see the progress of the chocolate article during production.

While not shown in FIG. 12, the automated control system 1200 may also provide various visual or sound cues when a mold 110 has reached a particular point in the custom manufacturing process. For example, a unique sound (bell, whistle, chime, etc.) may be issued from a speaker when the mold 110 leaves the exclusion depositor 120, or when it enters or exits from the cooling tunnel(s), or after packaging has been completed. Optical sensors or other similar sensors may be used to detect when the mold 110 is at specific points in the manufacturing process.

Although the dosing control subsystem 1280, the exclusion depositing control subsystem 1281, the packaging control subsystem 1282, and the conveyor control subsystem 1283 are conceptually shown for purposes of illustration as separate functions, their functionality may be combined into one or more units, may be incorporated into the main controller 1213, may be subdivided into additional sub-functions, or may be omitted where a particular function is not utilized, all depending upon the particular needs of a given implementation.

While the preferred embodiments illustrated in FIGS. 1 and 2 and elsewhere herein utilize a cooling tunnel for cooling the molds 110 after the deposit of exclusions in the tempered liquid chocolate, it may be possible to cool the mold 110 in a different manner. For example, the simplest technique may be to manually place the mold 110 in a refrigeration unit or blast chiller for a given period of time, e.g., possibly as short as 5 minutes. The properties of the mold 110, including the thin walls and single cavity (or limited cavities), may in such a case help facilitate rapid cooling. Alternatively, the mold 110 may be moved onto a chilled induction plate or in a refrigerated chamber for a given period of time prior to being placed in the cooling tunnel, in order to increase overall cooling speed and reduce the amount of time needed in the cooling tunnel (which would allow a shorter cooling tunnel, thereby saving space in retail locations that are relatively small). The chilled induction plate may be set to a temperature cooler than the cooling tunnel, lower than 50 degrees Fahrenheit for example. Other techniques for potentially accelerating the cooling process include adding Beta 6 cocoa butter to the chocolate in the tempering machine, spraying Beta 6 cocoa butter on the mold 110 prior to it being filled with tempered liquid chocolate, or spraying the mold 110 with a food-grade aerosol coolant, typically sprayed from a can. Having a shallower mold cavity 110 (for a thinner chocolate bar) will also accelerate cooling time. In some embodiments, tempered liquid chocolate may not be needed, but rather a pre-made compound shell, or compound wafers, in a mold 110 may be melted (by convection, microwave, etc.) to be just soft enough to allow exclusions to be deposited so that they settle and firmly attach to the compound; in such a case, because the compound may not start as warm as melted, tempered liquid chocolate, it may not need to be cooled for as long a period. In addition, an onsite tempering chocolate tank/melter may not be needed.

Where different size molds 110 are provided, a single cooling tunnel size may not be optimal for all of the different sized molds. In some cases, a shorter cooling tunnel may be used, with the smaller molds passing through the cooling tunnel once, and the larger molds being sent through the cooling tunnel twice.

Additional steps or modifications may be added to any of the foregoing embodiments for the purpose of providing increased flexibility or variety. For example, flavoring may be added to the chocolate article to enhance or alter the basic chocolate taste and provide more customization opportunities for the consumer. Because chocolate has a specific chemistry, however, one cannot add any type of off-the-shelf flavoring. Rather, according to a preferred method, flavored cocoa butter is used as a flavoring agent for this purpose, and is preferably made with Beta 6 crystals (which are the smallest and most stable cocoa butter crystals). The same kinds of flavoring agents that are compatible with (e.g., lipo-soluble) and commonly used for directly flavoring chocolate in mass production settings may be used to flavor cocoa butter instead. Different types of flavored cocoa butter, such as raspberry, blueberry, orange, mint, lemon, cherry, watermelon, apple, etc., may be kept in squirt bottles or, in a more automated system, in small holding tanks with one or more automated dosing heads. In either case, the flavored cocoa butter is preferably maintained at a warm temperature to keep the cocoa butter sufficiently fluid such as approximately 86° F. To accomplish this, the flavored cocoa butter bottles may be kept in a warming container/tray, or in the more automated system may be heated moderately with any standard heating elements. The flavored cocoa butter is preferably added to the mold 110 after the tempered liquid chocolate is dispensed in the mold 110, but before the exclusions are added. The mold 110 with the added flavored cocoa butter may be vibrated, either before or after the exclusions.

As an alternative to using flavored cocoa butter, it may also be possible to add chocolate-compatible flavoring agents directly to the tempered liquid chocolate in the mold. In such a case, different flavoring agents (e.g. particulates) for each type of chocolate (e.g. dark, milk and white) must be kept on hand, since each type of chocolate has different characteristics such as cocoa butter content and hence needs a flavoring agent with particular qualities. By contrast, the same type of flavored cocoa butter could be directly added to any type of chocolate, whether dark, milk or white.

It is possible to provide predefined combinations of chocolate type(s), topping(s), and/or flavoring(s) (where provided) that may be selected, for example, via the user interface 1202 (see FIG. 12) in an automated or semi-automated system. Examples of predefined combinations may be relatively simple, e.g., a milk/white chocolate combination swirl or divided mold, or else may be relatively complex with colorful or suggestive names, such as the following:
Caramel Coffee Toffee Almond Crunch: a combination of dark chocolate, coffee flavoring, and several exclusion toppings including chocolate-covered coffee or espresso beans, caramel candies, toffee buttercrunch bits, and toasted almond pieces
DragonBreath™: a combination of white chocolate, habanero chile flavoring, and a variety of toppings including Red Hots®, Hot Tamales®, Atomic Fire Balls®, and caramelized chile bits
Very Berry Double Cherry™: a combination of milk chocolate and raspberry jelly beans, strawberry POP ROCKS®, strawberry taffy, strawberry gummi bears, blue raspberry Sour Patch® Kids, Cherryhead® cherry candies, cherry gummi worms, Jolly Rancher® Cherry Stix, and Sour Patch® Cherries
   The selection of a particular predefined combination will cause the automated control system to activate the machinery to make the appropriate selections of chocolate, flavoring and exclusions for the customer's mold according to processes already described. In some cases, if desired, the selection may specify some of the chocolate article features (such as flavoring(s) and/or topping(s)) while leaving other features (such as chocolate type) to the choice of the consumer.

As another possible enhancement, the custom chocolate article manufacturing system and process may include use of a transfer sheet within the mold to apply a particular design to the chocolate article. The transfer sheet design may be created in any of a variety of different ways. For example, the retail or point-of-sale location may have stored transfer sheets or else, if a transfer sheet “printing” machine is onsite, may have a database of stored digital images from which a customer may select. The transfer sheet printing machine converts the image to a set of instructions for applying colored cocoa butter to the transfer sheet to match the image. Along these same lines, the onsite location may allow the customer to type in a message or else provide an image to be scanned (including a photographic image) which in turn can be automatically converted to colored cocoa butter on the transfer sheet. Once the transfer sheet is created, it is placed on the bottom of the mold with the exposed colored cocoa butter surface facing upwards, so that when the liquid chocolate is added the image on the transfer sheet adheres to the chocolate.

Although the preferred embodiments are described in relation to point-of-sale or retail locations, they may also have applicability to other environments, such as fulfilling custom chocolate orders made by customers online, by phone or by mail, for instance.

While preferred embodiments of the invention have been described herein, many variations are possible which remain within the concept and scope of the invention. Such variations would become clear to one of ordinary skill in the art after inspection of the specification and the drawings. The invention, therefore, is not to be restricted except within the spirit and scope of any appended claims.

1. (canceled)

2. A method for customizing chocolate articles at an onsite location, comprising:
(a) heating chocolate into a liquefied state;
(b) tempering the liquefied chocolate;
(c) dispensing the liquefied chocolate directly into a rigid single-use, single-article disposable open-face mold, thereby forming a flat top surface of liquefied chocolate dispensed in the rigid single-use, single-article disposable open-face mold;
(d) providing a plurality of containers holding a plurality of solid food products at the onsite location, each of which can be used as a solid food product exclusion for a customized chocolate article;
(e) selecting, from among the available solid food products, at least one solid food product exclusion for the customized chocolate article;
(f) adding the selected at least one solid food product exclusion to the top surface of the liquefied chocolate while the liquified chocolate remains in the single-use, single-article disposable open-face mold;
(g) conveying the combined liquefied chocolate and selected at least one solid food product exclusion on an automated conveyor through a cooling tunnel at the onsite location to create a customized chocolate article;
(h) releasing the customized chocolate article from the cooling tunnel; and
(i) repeating steps (c) through (h) for different selections and combinations of solid food product exclusions selected from the available solid food products, each time with a new rigid single-use, single-article disposable open-face mold, to produce a series of customized chocolate articles with different selections and combinations of solid food product exclusions at the onsite location.

3. The method of claim 2, further comprising packaging the customized chocolate article in a single-article box while it remains in the single-use, single-article disposable open-face mold.

4. The method of claim 2, wherein said chocolate is heated and tempered using a temperature-controlled chocolate tempering machine comprising a lifting wheel, an agitator and a heating element.

5. The method of claim 2, further comprising selecting the single-use, single-article disposable open-face mold from a plurality of different sized single-use, single-article disposable open-face molds at the point-of-sale location, and wherein the step of dispensing the liquefied chocolate comprises the step of dispensing the liquefied chocolate from a container through only one of a plurality of different sized spout openings based upon the size of the selected single-use, single-article disposable open-face mold.

6. The method of claim 5, wherein the selected at least one solid food product exclusion is added to the liquefied chocolate in the selected single-use, single-article disposable open-face mold using an exclusion dispensor comprising a funnel having dimensions corresponding to those of the selected single-use, single-article disposable open-face mold, and wherein said method further comprises guiding the one or more selected solid food product exclusions via the funnel atop the liquid chocolate in the selected single-use, single-article disposable open-face mold.

7. The method of claim 6, wherein said exclusion dispensor comprises a grate located within said funnel, said grate having a plurality of holes of different sizes.

8. The method of claim 7, wherein the holes of said grate are arranged across a planar surface of said grate so as to provide substantially even distribution of different-sized food product exclusions over the liquid chocolate in the selected single-use, single-article disposable open-face mold.

9. The method of claim 2, further comprising mechanically vibrating the single-use, single-article disposable open-face mold with the combined liquid chocolate and one or more solid food product exclusions before it enters the cooling tunnel.

10. The method of claim 9, wherein said step of mechanically vibrating the single-use, single-article disposable open-face mold is carried out at a vibrating station for an amount of time sufficient to reduce air bubbles in the liquid chocolate and facilitate an even distribution of the one or more solid food product exclusions across an external surface of the liquid chocolate.

11. The method of claim 9, wherein the single-use, single-article disposable open-face mold is vibrated for between about 5 and 15 seconds.

12. The method of claim 2, further comprising adding one or more cocoa butter flavorings to the tempered, liquid chocolate while in the single-use, single-article disposable open-face mold.

13. The method of claim 2, wherein the single-use, single-article disposable open-face mold remains in said cooling tunnel for between about 8 and 12 minutes.

14. The method of claim 13, wherein the temperature of said cooling tunnel is between about 50 and 58 degrees Fahrenheit.

15. The method of claim 14, wherein the relative humidity within said cooling tunnel is maintained at 55% or less.

16. The method of claim 13, wherein said cooling tunnel comprises a metal or alloy mesh conveyor belt to provide convective coupling between the bottom of said single-use, single-article disposable open-face mold and the interior of said cooling tunnel.

17. The method of claim 2, further comprising automatically conveying said single-use mold from a temperature-controlled chocolate tempering machine to an exclusion dispensor after chocolate is dispensed into said single-use, single-article disposable open-face mold, and automatically conveying said single-use mold from the exclusion dispenser to said cooling tunnel.

18. The method of claim 2, wherein the onsite location is a point-of-sale location, the method further comprising heating and tempering a plurality of different chocolate types simultaneously in a plurality of temperature-controlled chocolate tempering machines at the point-of-sale location, wherein said step of dispensing the liquefied chocolate into said single-use, single-article disposable open-face mold comprises selecting at least one of the different chocolate types from among the plurality of different chocolate types.

19. The method of claim 18, further comprising dispensing a plurality of different types of liquefied chocolate into said single-use, single-article disposable open-face mold.

20. The method of claim 18, further comprising tagging the single-use, single-article disposable open-face mold with a unique readable identifier before it is filled with tempered, liquid chocolate, wherein the unique readable identifier identifies a customer who has requested the customized chocolate article contained in the single-use, single-article disposable open-face mold.

21. The method of claim 18, further comprising the step of weighing the single-use, single-article disposable open-face mold on a scale after liquid chocolate has been dispensed therein to facilitate determination of a price for the customized chocolate article to be charged at the point-of-sale location.

22. The method of claim 21, further comprising the step of automatically controlling the amount of liquid chocolate dispensed into said single-use, single-article disposable open-face mold using an automated controller responsive to the measured weight.

23. The method of claim 2,
wherein the selected solid food product exclusion is combined with the liquefied chocolate using an exclusion dispensor comprising a hopper;
wherein the one or more solid food product exclusions are selected from a plurality of available food product exclusions;
wherein said hopper comprises a grate with different sized openings for permitting different sized solid food product exclusions to be deposited onto said single-use, single-article disposable open-face mold when placed beneath the hopper; and
wherein the hopper is mechanically vibrated to cause the one or more solid food product exclusions contained within the hopper to pass through the grate and onto the liquid chocolate in the single-use, single-article disposable open-face mold.

24. A method for creating customized chocolate articles at a point-of-sale location, comprising the steps of:
(a) providing a plurality of tempered, liquid chocolate types in separate containers at the point-of-sale location;
(b) in response to a customer chocolate type selection, dispensing a selected one of the plurality of tempered, liquid chocolate types directly into a rigid single-use, single-article disposable open-face mold at the point-of-sale location, thereby forming a flat top surface of liquefied chocolate dispensed in the rigid single-use, single-article disposable open-face mold;
(c) vibrating the single-use, single-article disposable open-face mold to remove air bubbles at a vibrating station;
(d) in response to a customer exclusion type selection, depositing a selected solid food product exclusion, from among a plurality of available solid food product exclusions at the point-of-sale location, atop the liquid chocolate while the liquified chocolate remains in the single-use mold;
(e) conveying the combined liquid chocolate and added solid food product exclusion through a cooling tunnel using an automatic conveyor to create a customized chocolate article;
(f) dispensing the single-use, single-article disposable open-face mold with the customized chocolate article from the cooling tunnel; and
(g) repeating steps (b) through (f) for different selections of chocolate type and different solid food product exclusions made at the point-of-sale location to create, on demand for customers, a plurality of customized chocolate articles with different combinations of chocolate type and solid food product exclusions at the point-of-sale location.

25. The method of claim 24, wherein the single-use, single-article disposable open-face mold is kept in said cooling tunnel for between about 8 and 12 minutes, and wherein the temperature within said cooling tunnel is maintained at less than about 58 degrees Fahrenheit.

26. The method of claim 24, wherein said step of depositing the selected solid food product exclusion atop the liquid chocolate comprises the steps of:
placing the solid food product exclusion into a hopper, said hopper comprising a grate having different sized openings for permitting different sized solid food product exclusions to be deposited and distributed evenly onto a the single-use, single-article disposable open-face mold when positioned beneath the hopper;
vibrating the hopper to cause the solid food product exclusions contained within the hopper to pass through the grate and onto the liquid chocolate contained in said single-use, single-article disposable open-face mold.
